(19) United States
(12) Patent Application Publication
(10) Pub. No.: US 2026/0023544 A1
(43) Pub. Date: Jan. 22, 2026

(54) METHODS AND SYSTEMS FOR OPTIMIZING COMPUTER CODE

(71) Applicant: Ribbon Optimization Software LLC, Troy, MI (US)

(72) Inventor: Adam Hug, Troy, MI (US)

(73) Assignee: Ribbon Optimization Software LLC, Troy, MI (US)

(21) Appl. No.: 19/088,907

(22) Filed: Mar. 24, 2025

Related U.S. Application Data
(60) Provisional application No. 63/672,305, filed on Jul. 17, 2024.

(51) Int. Cl. G06F 8/41; G06F 8/72

(52) U.S. Cl. CPC G06F 8/443; G06F 8/72

(57) ABSTRACT

A computer implemented method for compiling a computer program, the method including receiving a source code for a computer program, use-case data, and user-selected operating parameters, inserting optimization hook code into the source code based upon identified code loops, compiling source code with optimization hook code, executing the compiled code with optimization hooks code, wherein the optimization hooks of the optimization hook code are set to an initial value, receiving intermediate code based upon the executing, compiling the received intermediate code, executing the compiled received intermediate code using the use-case data, evaluating the executing the compiled received intermediate code using the use-case data based upon performance metrics, identifying code associated with preferential performance metrics, and compiling the identified code into a runnable computer program.

### TECHNICAL FIELD

This disclosure relates to compiling computer code, and more particularly to methods and systems for optimizing high-level computer code.

### BACKGROUND

The statements in this section merely provide background information related to the present disclosure and may not constitute prior art.

The design and implementation of high-performance software algorithms is often a manual, time-consuming exercise. Starting with a generic program, the process of performance optimization requires timing, testing and maintaining multiple versions of a single algorithm written for different hardware and use-cases. For example, often a programmer will write a high-level algorithm in C++ for compiling into assembly code such as x86 assembly code. This compiled x86 assembly code is not directly optimized for time, energy, specific hardware, or specific use-cases.

Therefore, a need exists for systems and methods that can automatically generate multiple specialized, high performance programs from a single, testable source code. In this way, software developers could more efficiently design, maintain and deploy software for a wide variety of unique problems.

### SUMMARY

A computer implemented method for compiling a computer program, the method including receiving a source code for a computer program, use-case data, and user-selected operating parameters, inserting optimization hook code into the source code based upon identified code loops, compiling source code with optimization hook code, executing the compiled code with optimization hooks code, wherein the optimization hooks of the optimization hook code are set to an initial value, receiving intermediate code based upon the executing, compiling the received intermediate code, executing the compiled received intermediate code using the use-case data, evaluating the executing the compiled received intermediate code using the use-case data based upon performance metrics, identifying code associated with the performance metrics, and compiling the identified code into a runnable computer program.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary system for optimizing code, in accordance with the present disclosure; and

FIG. 2 is a block diagram depicting a conventional compiling process;

FIG. 3A shows an exemplary system for optimizing computer code, in accordance with the present disclosure;

FIG. 3B shows an exemplary process for optimizing high-level computer code using the system, in accordance with the present disclosure;

FIG. 3C shows an exemplary process to call into a pre-compiled library of functions component using an application programming interface, in accordance with the present disclosure;

FIG. 3D shows an exemplary process to call into a pre-compiled library of functions component using the user interface, in accordance with the present disclosure;

FIG. 4A shows exemplary source code, in accordance with the present disclosure;

FIG. 4B shows an exemplary command structure that may be used in MATLAB, in accordance with the present disclosure;

FIG. 4C shows an exemplary command for inputting structural data into compute_Hx.c, in accordance with the present disclosure;

FIG. 5 shows an exemplary numeric optimization problem that may be used in accordance with the present disclosure;

FIGS. 6A and 6B show exemplary non-zero pattern for matrices H and C, in accordance with the present disclosure;

FIGS. 7A-7C show exemplary output of a sym-ca command, in accordance with the present disclosure;

FIGS. 8A-8D show an exemplary navigable workspace folder structure that may be generated, in accordance with the present disclosure;

FIG. 9A shows an exemplary header file fixed_inputs.h, in accordance with the present disclosure;

FIG. 9B shows an exemplary header file timing_inputs.h, in accordance with the present disclosure;

FIG. 9C shows an exemplary header file with optimization hooks, in accordance with the present disclosure;

FIGS. 9D-9I show an exemplary generated source code with optimization hooks compute_Hx_symbolic_overloads.c, in accordance with the present disclosure;

FIG. 10 shows the contents of an exemplary file optimization_hooks.txt that may be used in accordance with the present disclosure;

FIGS. 11A-11B shows the contents of an exemplary first executable, compute_Hx_optimizing_code_generator.c, in accordance with the present disclosure;

FIG. 12 shows the contents of an exemplary optimization_hook_values.txt file that may be used in accordance with the present disclosure;

FIG. 13 shows the contents of an exemplary file compute_Hx_partial_specializations.h that may be used in accordance with the present disclosure;

FIGS. 14A-14B shows an exemplary second timing executable file contents that may be used in accordance with the present disclosure;

FIGS. 15A-15B shows an exemplary first trial code file contents that may be used in accordance with the present disclosure;

FIG. 16 shows an exemplary file optimization_hooks_values.txt that may be used in accordance with the present disclosure;

FIGS. 17A-17C shows an exemplary new new source code file after generating new hook values, in accordance with the present disclosure;

FIG. 18 shows an exemplary function, in accordance with the present disclosure;

FIG. 19 shows an exemplary sorting network for 4 inputs, in accordance with the present disclosure;

FIG. 20 shows an exemplary process pipeline for N=4 that may be used to implement a preferential sorting network, in accordance with the present disclosure; and

FIGS. 21A-21C show exemplary code to simulate model predictive control of a quadrotor drone, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in some embodiments,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

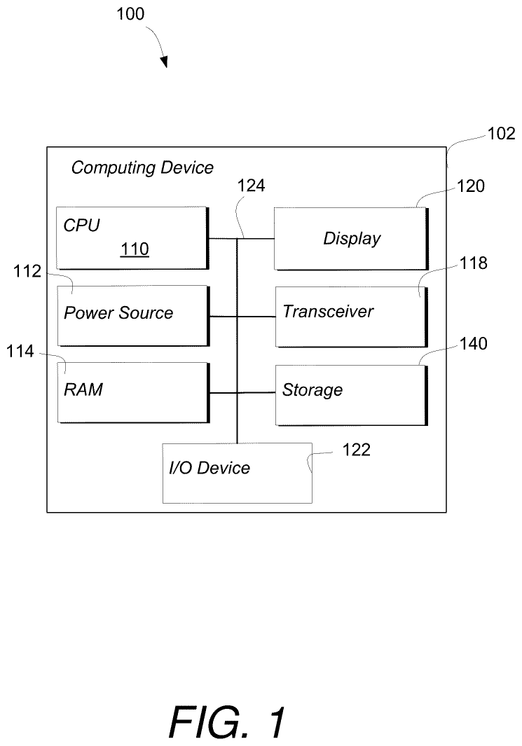

Referring now to the drawings, wherein the depictions are for the purpose of illustrating certain exemplary embodiments only and not for the purpose of limiting the same, FIG. 1 schematically shows an exemplary system 100 that may help implement the methodologies of the present disclosure. The system 100 is shown having a single computing device 102 that may be a server or client computer or mobile device. In some embodiments, the system 100 may incorporate multiple computing devices communicatively connected via a network. Components are shown of a single exemplary computing device 102 for ease of description, but it should be recognized that the system 100 may include multiple additional mobile and computing devices.

In some embodiments, the computing device 102 can be embodiments of a computer including high-speed microcomputers, minicomputers, mainframes, and/or data storage devices. The device 102 may execute database functions including storing and maintaining a database and processes requests from another device. The device 102 may additionally provide processing functions for another device.

The computing device 102 may include one or more applications that the user may operate. Operation may include downloading, installing, turning on, unlocking, activating, or otherwise using the application. The application may comprise at least one of an algorithm, software, computer code, and/or the like, for example, software for compiling computer code.

As shown in FIG. 1, the device 102 includes a processing unit 110, i.e., CPU, operatively coupled with a power source 112 and memory 114, i.e., RAM. The processing unit 110 may take the form of one or more computer processing units or microcontrollers that are configured to perform operations in response to computer-readable instructions, or other processing components such as an Application-Specific Integrated Circuit (ASIC). The processing unit 110 may be operatively coupled with the memory 114 via one or more electrical connections such as an electronic bus 124 or bridge. In some cases, the processing unit 110 and memory may be integrated on a single chip.

In some embodiments of the computing device 102, a transmitter and/or receiver 118 may be included. The transceiver 118 may be operatively coupled with the processing unit 110 via the electronic bus 124, bridge, flex connection, and so on. The transceiver 118 may include one or more radios, antennas, or other components for transmitting and/or receiving communications.

In some cases, the computing device 102 may include a display 120 and one or more input/output devices 122 such as a keyboard and computer mouse. The display 120 and input/output device(s) 122 may be operatively coupled with the processing unit 110.

As shown in FIG. 1, the computing device 102 includes a processing unit 110 i.e., CPU, operatively coupled with a power source 112 and memory 114, i.e., RAM. The processing unit 110 may include one or more computer processing units, microcontrollers or other processing units (such as an ASIC, microprocessor, system-on-chip, field-programmable gate array, or the like) that are configured to perform operations in response to computer-readable instructions or other inputs. The processing unit 110 may be operatively coupled with the memory 114 via one or more electrical connections such as an electronic bus 124 or bridge. In some cases, the processing unit 110 and memory may be integrated on a single chip.

In some embodiments, the computing device 102 includes a storage medium 140 configured to store, access, and modify a database, and is preferably configured to store, access, and modify structured or unstructured databases for data including, for example, relational data, and tabular data, consistent with the teachings herein.

In some embodiments, the storage medium 140 is configured to store instructions executable with the processor 110; may be on removable storage media or in other memory (volatile or non-volatile or both). The instructions may be stored as binary instructions that are executable by the processor 110; “executable” is used in a broad sense herein to include machine code, interpretable code, bytecode, and/or code that runs on a virtual machine, for example. The storage medium 140 is also configured with data 118 which is created, modified, referenced, and/or otherwise used for technical effect by execution of the instructions. The instructions and the data configure the memory or other storage medium in which they reside; when that memory or other computer readable storage medium is a functional part of a given computer system, the instructions and data also configure that computer system.

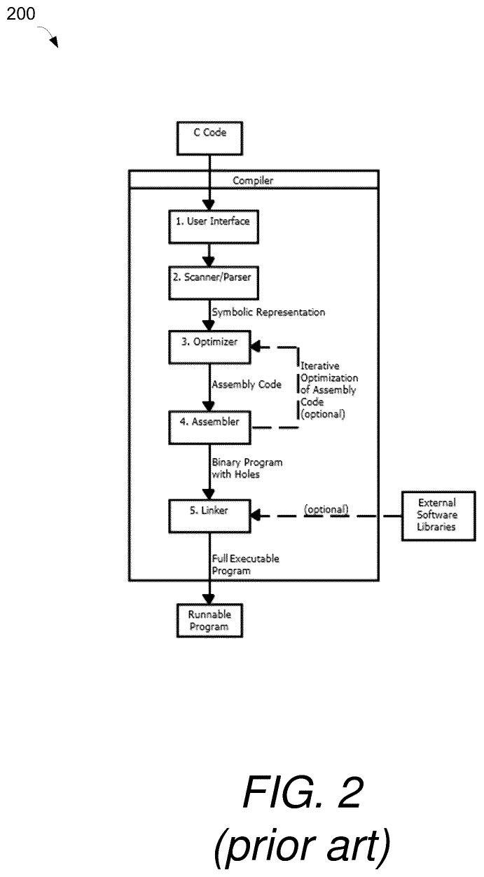

FIG. 2 shows a block diagram of a known C code compiler process 200. As FIG. 2 shows, the compiler 200 the compiler performs a translation from source code to machine-specific assembly code to produce a program that can be run on a computer. This process has five main stages. First, through a user interface, a user may direct the compiler to generate code in a specific way, e.g., for x86 execution, and specific embedded software packages. Next, the compiler utilizes a scanner/parser. This portion of the compiler reads through all the text files containing user code and builds a symbolic representation of how different pieces of code interact with others.

Next, the compiler uses an Optimizer for transformations to the symbolic representation using a pre-determined library of heuristics. This produces machine-specific assembly code specifying the instructions that will be used to execute the user's original code.

Next, the compiler uses an assembler to convert the Optimizer's sub-optimal, machine-specific assembly code into bytecode, e.g., 1's and 0's.

Next, the compiler uses a Linker, to couple them together into a single executable program.

This process 200 can be applied to any generic program written in C. Naturally, all optimization strategies employed by the compiler seek to provide improvements to a wide breadth of applications. These are often fixed and inadequate for high performance computing environments. Hence, there is a need for significant improvements in the Optimizer and Assembler stages.

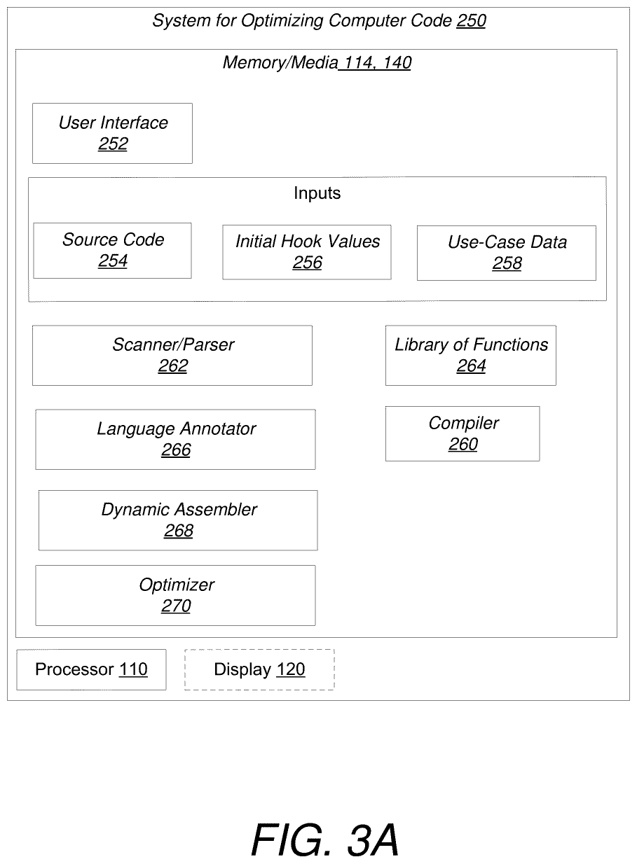

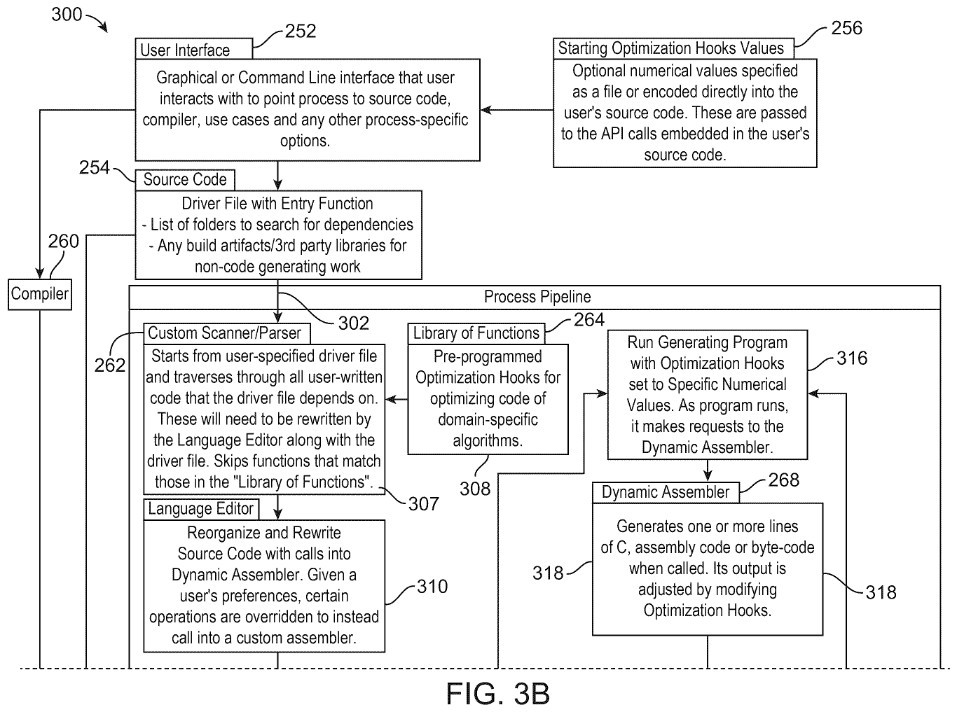

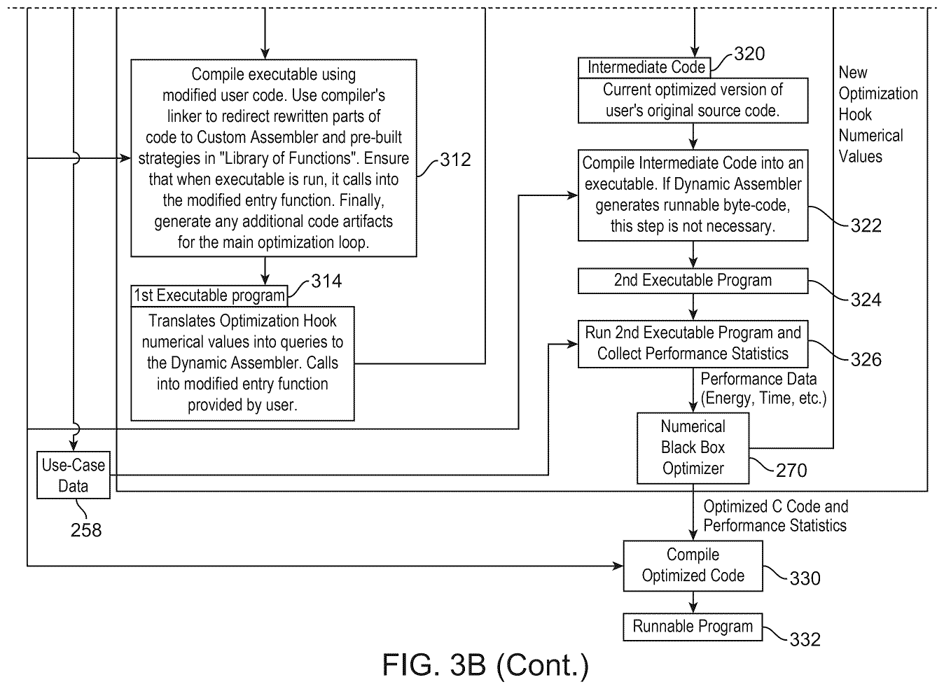

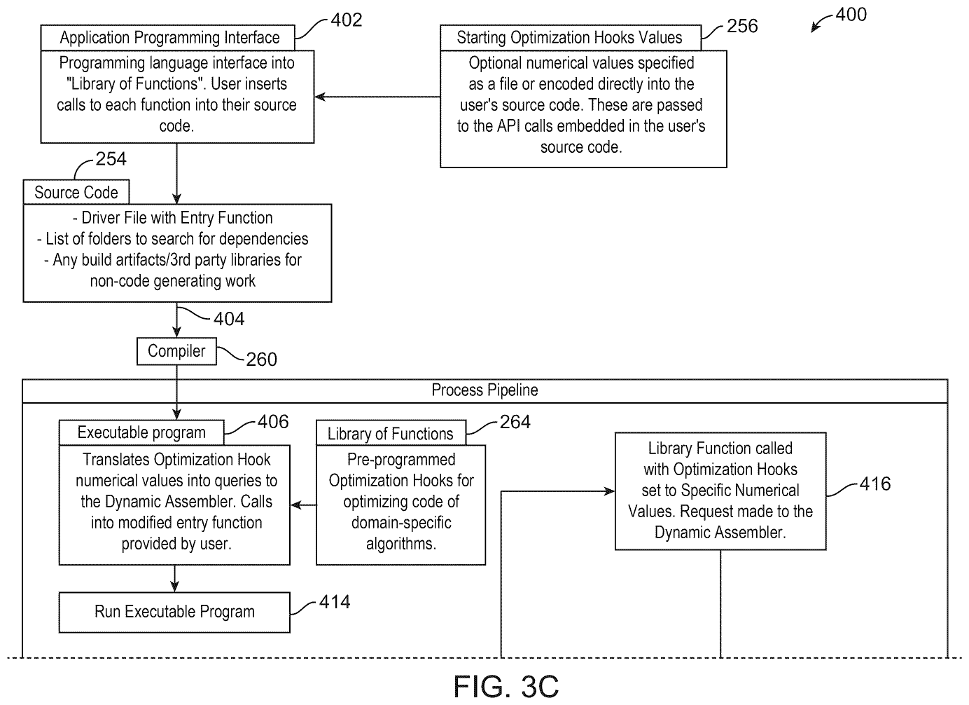

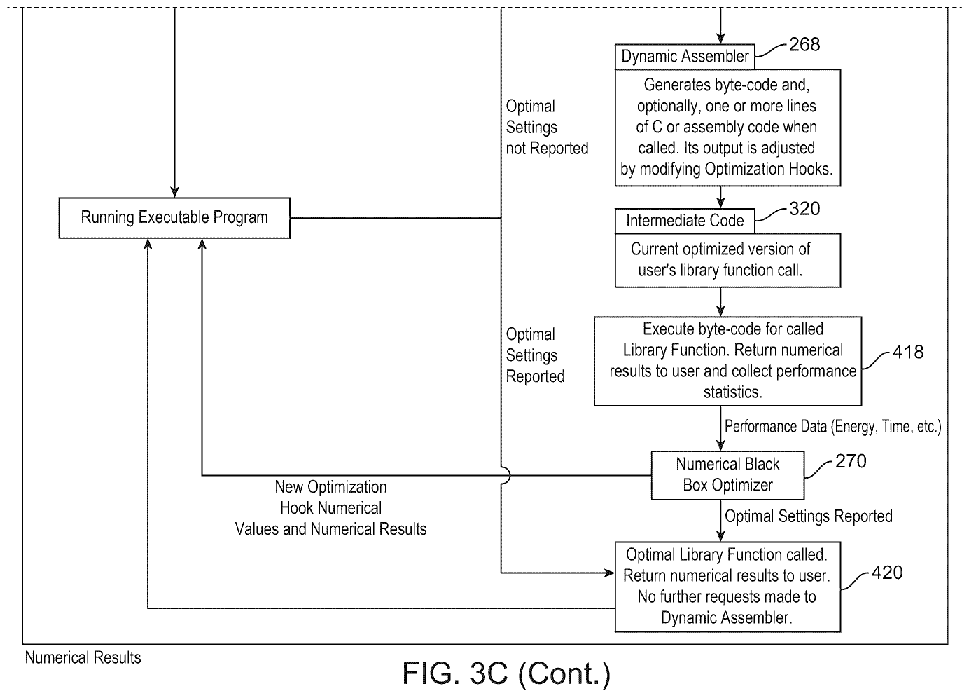

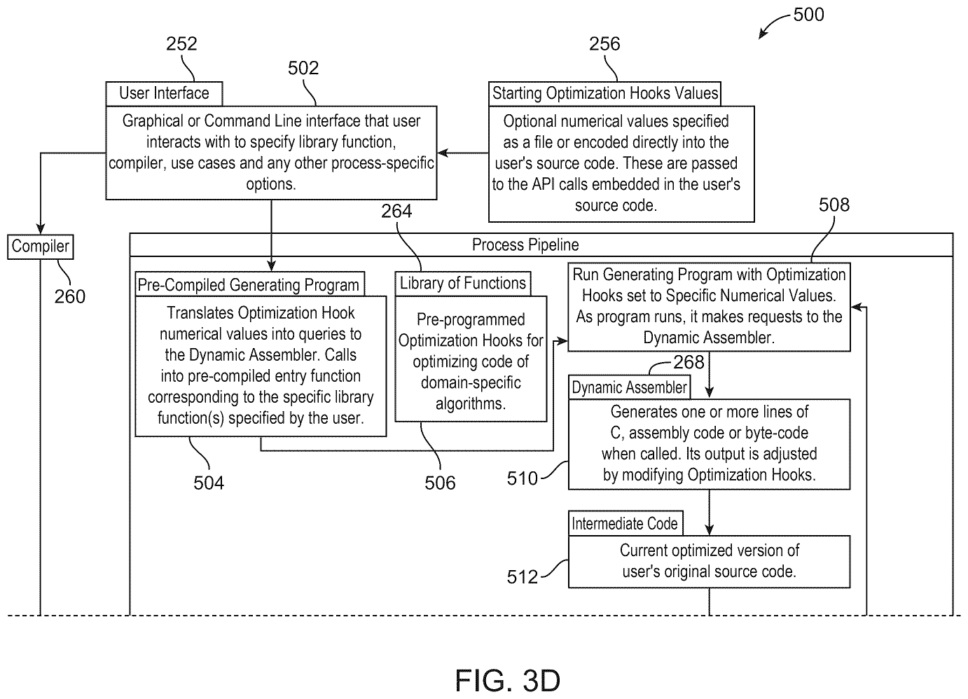

FIG. 3A shows an exemplary system 250 for optimizing computer code. The system 250 may be implemented within a computing device such as the computing device 100 shown and described with reference to FIG. 1, or other known computerized device. The system 250 includes memory 114 and a storage media 140, such as described herein above with reference to the computing device 100.

A user interface 252 is included in the system 250. The user interface 252 may be used to direct inputs into the system 250. The user-interface 252, may be a graphical, command line or application programming interface (API) that a user can supply operating parameters into the system 250. In some embodiments, the user-interface 252 is configured to point the system 250 to source code 254, the compiler 260, use-cases data 258 and any other process-specific options. The user interface 252 may be configured to permit the user to direct the dynamic assembler 268 to generate code in a specific way, e.g., for x86 execution, and specific embedded software packages. In some embodiments, a user may use the user-interface 252 to set initial hook values 256.

The source code 254, in one example, may contain code written in a high-level programming language such as the C++ programming language. The source code 254 can be supplied by a user into the system 250 via the user-interface 252. The source code 254 can include a driver file including, e.g., one or more entry functions, a list of folders to search for dependencies, any build artifacts, and/or 3^{rd} party libraries for non-code generating work.

The compiler 260 may be, but not limited to, GNU Compiler Collection, Microsoft Visual C++, Clang or any compiler that would transform source code to an executable computer program. The compiler 260 can redirect rewritten parts of code to a dynamic assembler component 268 and/or pre-built strategies in a library of functions component 264. In some embodiments, the compiler 260 may be configured to include one or more modified entry functions that can be called when an executable is run. In some embodiments, calls into a modified entry function are provided by a user, which may be input via the user interface 252.

In some embodiments, the compiler 260 can generate any additional code artifacts to update the optimization hook values. Compiling the source code 254 with the optimization hooks generates an executable. The executable, when run, can generate an intermediate-level code, such as C code.

The use-case data 258, in some embodiments, may be generated by the user based upon common inputs to the user's functions within the source code. For example, if the source code has a variable that receives temperature information from a sensor, the use-case data may include a table of temperature values.

A scanner/parser component 262 is included in the system 250. The scanner/parser component 262 is configured to read the user-supplied source code 254 and analyze the user-specified driver files that the source code 254 depends upon. In some embodiments, the scanner/parser component 262 is configured to read through all the text files containing user code and builds a symbolic representation of how different pieces of code interact with others. In some embodiments, library substitutions are made. In some embodiments, predefined optimization hooks are supplied from a library of functions component 264. In some embodiments, functions matching a predefined library of functions 264 are not included in the scanner/parser component 262.

A language editor component 266 may be included in the system 250. The language editor component 266 is configured to reorganize and rewrite a copy of the source code 254 with optimization hooks and calls into a dynamic assembler component 268. Optimization hooks are generator functions that will insert code based on a numerical input. The optimization hooks will be used to modify the source code 254. For example, a first type of optimization hook may be included in a for-loop, wherein the numerical input will correspond to how many loops are unrolled. Other loop types may be unrolled in a similar manner.

In some embodiments, the optimization hook may correspond to one or more specific function calls. These can be user function calls or code library function calls, e.g., C library function calls, such as sine, cosine, etc. These values can be changed based upon the numerical input or other user controlled input described hereinbelow. The numerical input or other user controlled input are parameters that can be tuned. In some embodiments, these optimization hooks can be manually inserted to adjust some aspect of the generated code as well.

In some embodiments, the language editor component 266 is programmed to recognize certain functions as having a human-optimized symbolic version and will use that instead of inserting its own hooks. In some embodiments, the optimization hook may be dynamically adjusted instruction vectorization amounts. For example, in modern hardware, these values are 1, 2, 4, 8, . . . power of two. These values can be changed based upon the numerical input or other user-controlled input as described hereinbelow.

In some embodiments, the optimization hook may be opportunistically allowing associative floating point operations where (x+y)+z=x+(y+z). These values can be changed based upon the numerical input or other user-controlled input at step 312 described hereinbelow, such as into the 1^{st} executable program 314. In some embodiments, this optimization hook type may be controlled via user input, e.g., a manual option in the user-interface 252.

In some embodiments, the optimization hook may opportunistically allow distributive floating point operations where x*y+x*z=x*(y+z). These values can be changed based upon the numerical input or other user-controlled input as described hereinbelow.

In some embodiments, the optimization hook may be opportunistically enabling FORTRAN data assumptions for high performance computing. For example, FORTRAN assumes every data array can only be accessed through a single variable. C/C++ can allow multiple variables to access an array. In “C”, this assumption can be applied for each array by using the “restrict” keyword. However, most programs rarely take advantage of this feature and modern compilers are unable to opportunistically introduce this assumption because they lack overall context. The disclosure herein provides use-cases by the user which offer better context to make these optimizations. The restrict keyword can be changed based upon the numerical input, e.g., 0 or 1, or other Boolean operator, such as via the user-interface 252, or other user-controlled input, which is used at step 316 described hereinbelow.

In some embodiments, the optimization hook may be algorithm-specific optimization hooks: These will be applied to a built-in library of algorithms that are useful for the target user-base. For example, if the disclosure herein is used in the automated driving technology, the program could incorporate optimization hooks pertaining to the Alternating Direction Method of Multipliers (ADMM) which is frequently used to perform trajectory optimization for autonomous devices. In this example, the ADMM algorithm will be added to a library of recognized functions with algorithm-specific optimization hooks. Hooks that tune the generated code may include: the number of CPU cores to distribute computation over and the number of variables to assign to each processor core.

A more general example involves detecting dense/sparse Basic Linear Algebra Subroutine (BLAS) functions and applying algorithm-specific optimizations to these. These have been a quasi-standard for performing linear algebra computations. For a very expensive function, such as performing Matrix-Matrix multiplication, algorithm-specific optimizations include block tile size and custom register scheduling for the underlying assembly code. These properties can be changed based upon the numerical input or other user-controlled input as described hereinbelow.

The dynamic assembler component 268 may be included in the system 250. The dynamic assembler component 268 may be configured to generate one or more lines of intermediate code, such as C code, assembly code, or byte-code when called. Output from the dynamic assembler component 268 may be adjusted by modifying numerical values of the optimization hooks.

In various embodiments, the dynamic assembler component 268 detects the host processor's instruction set architecture (e.g. x86, x64, ARM64, ARM32, RISC-V, etc.) in order to query the processor's timing and energy information as well as recognizing hardware-specific instructions (e.g. x86-AVX2) that may be advantageous to the overall iterative optimization process. It then uses use-cases and/or user-context to build code ahead of time using an iterative process. In addition, the dynamic assembler component 268 may be provided numerical constraints in the form of optimization hooks and hardware statistics (such as cache size) that will influence how it generates code each iteration. This is all with the intent of increasing execution speed and minimizing energy. The dynamic assembler component 268 is unlike a traditional compiler (e.g., one that builds static code in a context-free environment) in that it is inserted into a dynamic framework: a framework that tries to adjust the code using new information gleaned from the user's program with each iteration. Use-cases and/or user-context is used to generate this new information (e.g. timing and energy statistics). In some embodiments, dynamic assembler component 268 may be configured to generate runnable byte-code.

The dynamic assembler component 268, can be called in two cases: dynamic and static. The static case involves calling the language editor 266 wherein a copy of the user's code is finalized after optimization. No further changes will be made by the process 300 and the user's original source code will remain available. In contrast, the dynamic case results in the user directly or indirectly (e.g. through the library of functions component 264) inserting calls to both the dynamic assembler 268 and the black box optimizer 270 into their original source code. This allows the user's original code to be changed and is re-configured to respond to queries based upon optimization hook numerical values. The end result is that the user's code is essentially unchanged with the exception of one or more optimization hook calls that are easily removed if desired.

The system 250 is configured to run a generated executable using an initial set of predefined numerical values for the optimization hooks. For example, if the optimization hook is a for-loop optimization type, and the numerical value is 5, then the system 250 will unroll the for-loop 5 times. Subsequently, the numerical values may be dynamically defined based upon time and/or energy metrics. In some embodiments, the numerical values are calculated as described herein below.

The system 250 is configured to compile intermediate-level code into a second executable computer program. This computer program will be executable consistent with the original source code's purpose. The system 250 can execute the second executable computer program to generate performance statistics based upon the use-case data 258. The performance statistics can be associated with time and/or energy requirements corresponding to output. For example, the system could measure the time required to calculate each use-case, or measure the energy required to calculate each use-case. The performance statistics can be associated with the numerical values used to generate the second executable computer program and the use-case data. In some embodiments, performance statistics are generated for each use-case.

An optimizer component 270 may be included in the system 250. The optimizer component 270 may be configured to execute a compiled program, which has been compiled using code from the dynamic assembler component 268, numerical values of the optimization hooks, and performance information from previous executions of compiled programs.

The optimizer component 270 can store the performance statistics associated with each use case, and associated with the optimization hook numerical values. The optimizer component 270 monitors to determine if a convergence to preferential solution has occurred. In some embodiments, the optimizer component 270 is configured to determine if a convergence to an optimal solution has occurred. If a convergence has not occurred, the system 250 can continue testing optimization hook numerical values while executing iterations of the second executable computer program.

FIG. 3B (static mode) shows an exemplary process 300 for optimizing high-level computer code using the system 250. As FIG. 3B shows, the process 300 begins at step 302 by inputting information into the system 250 such as use-case data 258, and a user's source code 254. Other operating parameters may be inputted into the system 250 via the user-interface 252, such as the initial hook values 256. The source code 254, in one example, may contain code written in a high-level programming language such as the C++ programming language. In some embodiments, a user can specify which library functions from the library of functions component 264 to optimize with respect to time/energy metrics over provided use-case data to interact with in the source code 254 and any other process-specific option.

After inputting operating parameters and inputs at step 302, the system 250 initiates a scanner/parser step 307 using the scanner/parser component 262 to generate a first amended copy of the source code via the language editor 266. The scanner/parser component 262 generates custom data structures and data used by the language editor 266 to generate modified source code. In this step, the system 250 reads and/or analyses the user-specified driver file (the driver file is the unique entry point into all of the user's source code) to review user-written code that the driver file depends upon. In some embodiments, the system 250 reads through all the text files containing user code and generates the first amended copy of the source code based upon a symbolic representation of how different pieces of code interact with others.

The process 300 can include, at step 308, substituting functions within the first amended copy of the source code with functions matching functions stored in a predefined library of functions component 264. In some embodiments, predefined optimization hooks are supplied from the library of functions component 264.

The process 300 continues at step 310, where the language editor component 266 of the system 250 will generate an amended copy of the source code based upon the data structures and information provided by the scanner/parser, operating parameters and inputs, and/or initial hook values. To generate the amended copy of the source code, the system 250 can reorganize the code, insert one or more optimization hooks, and can insert one or more calls into the dynamic assembler component 268. In some embodiments, given a user's preferences, certain operations are overridden to instead call into the dynamic assembler 268. Optimization hooks are generator functions that will insert code based on a numerical input. The optimization hooks will be used to generate a modified copy of the source code. For example, a first type of optimization hook may be included in a for-loop, wherein the numerical input will correspond to how many loops are unrolled at step 314 described hereinbelow, i.e., how many loops will replace the for-loop. Other loop types may be unrolled in a similar manner.

Another optimization hook may be one or more inline specific function calls. These can be user function calls or code library function calls, e.g., C library function calls, such as sine, cosine, etc. These values can be changed based upon the numerical input or other user controlled input at step 316 described hereinbelow. The numerical input or other user controlled input are parameters that can be tuned. These optimization hooks can be manually inserted to adjust some aspect of the generated code. In some embodiments, the language annotator component 266 is programmed to recognize certain functions as having a human-optimized symbolic version and will use that instead of inserting its own hooks.

Another optimization hook may be dynamically adjusted instruction vectorization amounts. For example, in modern hardware, these values are 1, 2, 4, 8, . . . power of two. These values can be changed based upon the numerical input or other user-controlled input at step 312 described hereinbelow.

Another optimization hook may be opportunistically allowing associative floating point operations where (x+y)+z=x+(y+z). These values can be changed based upon the numerical input or other user-controlled input at step 312 described hereinbelow. In some embodiments, this optimization hook type may be controlled via user input, e.g., a manual option in the user-interface component 252.

Another optimization hook may be opportunistically allow distributive floating point operations where x*y+x*z=x*(y+z). These values can be changed based upon the numerical input or other user-controlled input at step 312 described hereinbelow.

Another optimization hook may be opportunistically enabling FORTRAN data assumptions for high performance computing. For example, FORTRAN assumes every data array can only be accessed through a single variable. C/C++ can allow multiple variables to access an array. In “C”, this assumption can be applied for each array by using the “restrict” keyword. However, most programs rarely take advantage of this feature and modern compilers are unable to opportunistically introduce this assumption because they lack overall context. The disclosure herein provides use-cases by the user which offer better context to make these optimizations. The restrict keyword can be changed based upon the numerical input, e.g., 0 or 1, or other Boolean operator, such as via the user-interface 252, or other user-controlled input, which is used at step 316 described hereinbelow. In some embodiments, the underlying variables or use-case data controlled by virtue of the “restrict” optimization hook may be applied at step 328.

Another optimization hook may be algorithm-specific optimization hooks: These will be applied to a built-in library of algorithms that are useful for the target user-base. For example, if the disclosure herein is used in the automated driving technology, the program could incorporate optimization hooks pertaining to the Alternating Direction Method of Multipliers (ADMM) which is frequently used to perform trajectory optimization for autonomous devices. In this example, the ADMM algorithm will be added to a library of recognized functions with algorithm-specific optimization hooks. Hooks that tune the generated code include: the number of CPU cores to distribute computation over and the number of variables to assign to each processor core.

A more general example involves detecting dense/sparse Basic Linear Algebra Subroutine (BLAS) functions and applying algorithm-specific optimizations to these. These have been a quasi-standard for performing linear algebra computations. For a very expensive function, such as performing Matrix-Matrix multiplication, algorithm-specific optimizations include block tile size and custom register scheduling for the underlying assembly code. These variables can be changed based upon the numerical input or other user-controlled input at step 312 described hereinbelow.

The process 300 continues at step 312, where the system 250 will compile the amended copy of the source code with the compiler 260. The system 250 uses the compiler's linker function to redirect rewritten parts of code to the dynamic assembler component 268 and pre-built strategies in library of functions component 264. In some embodiments, the compiled code ensures that when an executable is run, it calls into a modified entry function as specified by the library of functions component 264. In some embodiments (static mode), the compiler can generate any additional code artifacts for the main optimization loop. Compiling the amended copy of the source code with the optimization hooks generates an executable. The executable, when run, will generate an intermediate-level code, such as C code.

The process 300 continues at step 314 where the system 250 will translate the optimization hook numerical values into queries to the Dynamic Assembler 318. In some embodiments, calls into modified entry functions are provided by a user, which may be inputted via the user interface (static mode) 252.

The process 300 continues at step 316, where the system 250 will run the generated executable to produce an intermediate-level code, such as C code. In some embodiments, the system 250 will run the generated executable using an initial set of predefined numerical values 256 for the optimization hooks. For example, if the optimization hook is a for-loop optimization type, and the numerical value is 5, then the system 250 will unroll the for-loop 5 times. Subsequently, the numerical values may be dynamically defined based upon time and/or energy metrics. In some embodiments, the numerical values are calculated as described herein below.

While running the executable at step 316, the system 250 can make requests to the dynamic assembler component 268. As described hereinabove, the dynamic assembler component 268 is configured to generate one or more lines of intermediate code, such as C code, assembly code or byte-code when called. In some embodiments, its output is adjusted by modifying optimization hooks.

Subsequent to running the executable at step 316 and utilizing the dynamic assembler component 268 at step 318, the system 250 at step 320 outputs a current optimized version of the user's original source code 254. In some embodiments, this is outputted as intermediate code, e.g., C code. This outputted as intermediate code includes code inserted based upon the numerical value of the optimization hooks. For example, unrolled for-loops unrolled by the amount corresponding to the numerical optimization hook values.

The process 300 continues at step 322, where the system 250 will compile the intermediate-level code 320 into a second executable computer program 324. This computer program 324 will be executable consistent with the original source code's purpose. In some embodiments, the dynamic assembler component 268 may be configured to generate runnable byte-code. If so, then this step 322 is not necessary.

The process 300 continues at step 326, where the system 250 will execute the second executable computer program 324 to generate performance statistics based upon the use-case data. The performance statistics can be associated with time and/or energy requirements corresponding to output. For example, the system could measure the time required to calculate each use-case, or measure the energy required to calculate each use-case. The performance statistics can be associated with the numerical values used to generate the second executable computer program and the use-case data. In some embodiments, performance statistics are generated for each use-case.

The process 300 continues at step 328, where the system 250 will pass the performance statistics to the optimizer component 270. The optimizer component 270 can store the performance statistics associated with each use case, and associated with the optimization hook numerical values. The optimizer component 270 monitors each iteration of step 324 to determine if a convergence to preferential solution has occurred. In some embodiments, the optimizer component 270 monitors to determine if a convergence to an optimal solution has occurred. If a convergence has not occurred, the system will transition back to step 316 using new optimization hook numerical values.

Whether a convergence has occurred can be determined using one or more techniques consistent with the teachings herein. One technique that may be used is to solve a mixed integer nonlinear optimization problem (MINLP) defined below:

$$minimize the function F ( {x}_{1} , {x}_{2} , … , {x}_{k} , … , {x}_{M} ) \qquad [ 1 ]$$

### Subject to:

$${c}_{e q} ( {x}_{1} , {x}_{2} , … , {x}_{k} , … , {x}_{M} ) = 0$$

$${c}_{i n e q} ( {x}_{1} , {x}_{2} , … , {x}_{k} , … , {x}_{M} ) \leq 0$$

where x₁, x₂, . . . , xₖ are optimization hooks assigned integer quantities xₖ₊₁, . . . . x_{M} are optimization hooks assigned numerical quantities not restricted to integers

The output of the objective function, F(x)), is a measure of fitness over all runs of user-specified tests. This will involve quantities such as the run time or power output of the specialized program, e.g., the second executable used in step 316 hereinabove. The constraints c_{ineg} and c_{eg} describe hardware constraints on the program. For example, such constraints c_{ineq}≤0 may include limiting the program's binary size to fit on local CPU memory (L1 or L2 cache), bounding program size from below to restrict the solver's search space, or logically coupling various parameters. In various embodiments, both the assembler and black box optimizer will both work in tandem to enforce preferential or user-selected constraints. In various embodiments, the black box optimizer 270 can be implemented within, or in conjunction with, a traditional computing device, a quantum computing device, hardware accelerators for graphics, neural network computations/artificial intelligence or tensor processing units.

Once a convergence has occurred, the process 300 can assemble and link the final runnable program together based upon the numerical values associated with the convergence, and the corresponding intermediate code associated therewith. The system 250 compiles this optimized code at step 330 and outputs a runnable program 332 consistent with the user's selected operating parameters.

In various embodiments, in the background, there can be a global dynamic assembler component that can be adjusted using the optimization hooks embedded in the intermediate code file(s). These hooks can be the mechanism by which the numerical black box optimizer adjusts the dynamic assembler component 268.

FIG. 3C shows an exemplary process 400 that may be used by a user to call into a pre-compiled library of functions component 264 using an application programming interface (API) 402. In some embodiments, the system 250 executes the process 400, which allows access to the library of functions component 264 via the API 402. Using the process 400, a user can insert calls to the library of functions component 264 directly into their code. Each library function will directly call into the dynamic assembler component 268 with minimal user intervention. In some embodiments, numerical values specified as a file or encoded directly into the user's source code may be inserted via the API 402. These numerical values may be passed to the user's inserted calls embedded in the source file. The dynamic assembler component 268 will generate and tune byte code as described hereinabove.

As FIG. 3C (dynamic mode) shows, the process 400 includes accessing the API 402 by the user. From the API 402, the user may selectively insert calls to selective functions into the source code 254 to generate a modified source code 404, which is then compiled into a first executable program 406.

The system 250 runs the first executable program 406 at step 414 and the system 250 generates intermediate code 320 by calling the library of functions component 264 (step 416) at iterative numerical values for the optimization hooks and the dynamic assembler component 268 as described hereinabove.

At step 418, the system 250 can execute the generated intermediate code 320 to generate performance statistics and return numerical results to the user. Once optimal settings are determined, the system 250 can call the library function (step 420) with optimal optimization hooks set to specific numerical values. The system 250 can return numerical results to the user and/or the system 250. No further requests made to the dynamic assembler component 268 are needed.

In some embodiments, embedding library function calls into a user's program is done by compiling the library functions, dynamic assembler and black box optimizer into one or more library files which can be distributed to users. When a user compiles their program, these library files are provided as inputs to the user's compiler. In FIG. 2, this is the “Linker” step. The executable program that is created by the compiler will then redirect all calls to library functions given in the “Application Programming Interface” to the “Process Pipeline” in FIG. 3C. When a library function is called by the “Running Executable Program” it executes one iteration of the feedback loop (steps 416-418). For example, if the user calls a library function ten separate times, the dynamic assembler component 268 generates ten separate intermediate codes, performance data is collected on each of them ten separate times and ten new optimization hook values are generated—assuming that the black box optimizer 270 has not reported “optimal settings” yet. If optimal settings are reported, the feedback loop process (steps 416-418) is skipped, the “optimal” code is called and the results are reported back to the user. In some embodiments, parallel calls to the dynamic assembler component 268 and the optimizer component 270 can be made in the user's code and this process will still work as expected.

FIG. 3D (library static mode) shows an exemplary process 500 that may be used by a user to call into a pre-compiled library of functions component 264 using the user interface 252. In some embodiments, the system 250 executes the process 500, which allows access to the library of functions component 264 via the user interface 252. Using the process 500, a user can specify which library functions from the library of functions component 264 to optimize with respect to time/energy metrics over provided use-case data. The system 250 then receives the specified library functions, at step 502.

At step 504, the system 250 translates optimization hook numerical values into queries to the dynamic assembler component 268, and calls into pre-compiled entry function corresponding to the specific library function(s) specified by the user.

At step 506, the system 250 can receive pre-programmed optimization hooks for optimizing code of domain-specific algorithms.

At step 508, the system runs a generating program with optimization hooks set to specific numerical values. As the program runs, it makes requests to the dynamic assembler component 268. The dynamic assembler component 268 functions as described hereinabove, when called, the dynamic assembler component 268 generates C-code, assembly code, or byte-code. Its output can be adjusted by modifying the optimization hooks.

Subsequent to running the generating program and calling the dynamic assembler component 268 at steps 508 and 510, the system 250, at step 512, outputs a current iteration of intermediate code. The current iteration of intermediate code is a current optimized version of the user's original source code.

At step 514, the system 250 can compile the current iteration of intermediate code into an executable. If the dynamic assembler component 268 has generated runnable byte-code, this step is not necessary.

At step 516, a second executable is outputted from the system 250.

At step 518, the system 250 can execute the second executable to generate performance statistics and return numerical results to the user and/or the system 250.

At step 520, the system 250 can change the optimization hook numerical values and return to step 508 to test source code's performance at the next iteration using those new values.

Once a predefined number of optimization hook numerical values are evaluated or once a convergence of optimization is determined by the optimizer component 270, the system 250 can use the optimization hook numerals corresponding to the best performing iteration, generate the code corresponding the optimization hooks of the best performing iteration, and compile that code at step 520.

The system 250 can output the executable program corresponding to the best performing iteration at step 522. Note that the user's original source has not been modified.

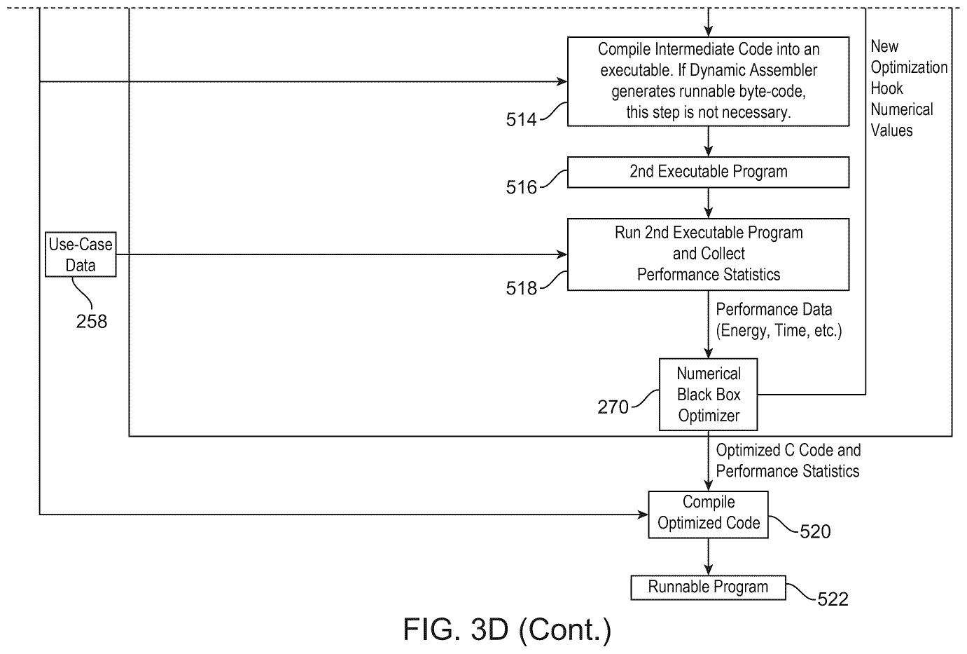

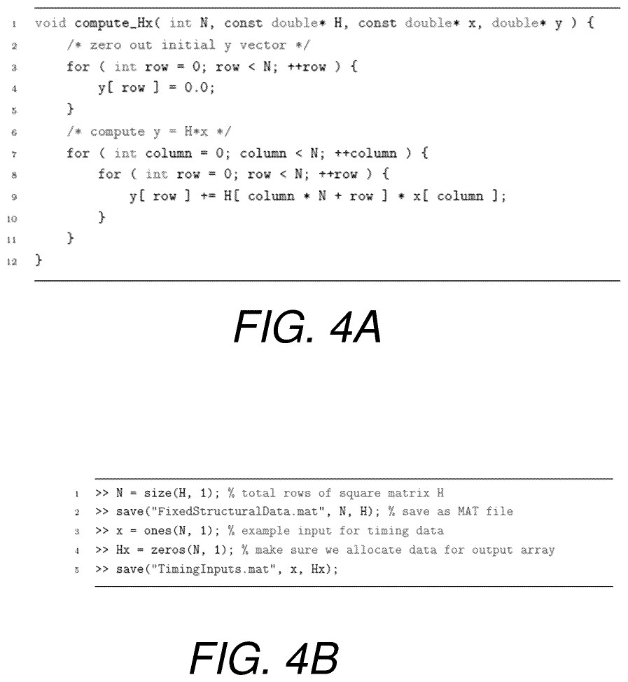

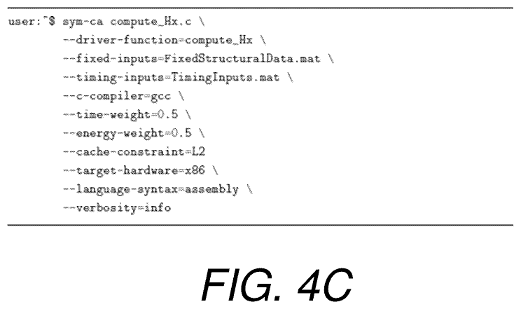

For the exemplary compute_Hx function shown in FIG. 4A, there are three optimization hooks that are generated by the Language annotator component 266—one for each for-loop. Each optimization hook takes a numeric input value and produces a specific code change depending on the hook type. In compute_Hx these are loop unroll optimization hooks. When a hook is set to N, it will unroll the first N iterations of the loop it has been assigned to.

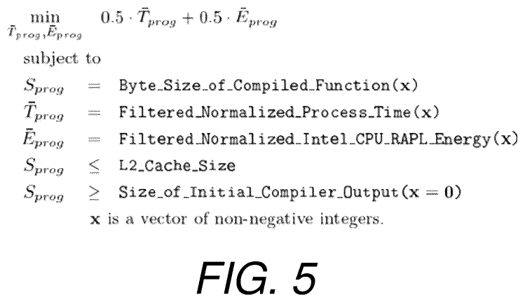

Denoting xᵢ as the numerical values for each optimization hook, an exemplary general optimization model for an Intel x86 processor is shown in FIG. 5.

The equation shown in FIG. 5 weighs time and energy equally. It is contemplated herein that the time and energy can be variables set by the user. Alternatively, time and energy can simply be weighted differently than provided above, e.g., 0.4 for Time and 0.6 for energy.

Time can be measured using the processor hardware or operating system's internal time-keeping mechanisms. The energy is measured by sampling the hardware's power monitoring circuitry. For modern Intel chips, this involves polling the Running Average Power Limit (RAPL) interface. Processors from Advanced Micro Devices (AMD) also have a similar power monitoring interface.

The final values x₁, x₂, . . . , xₖ, . . . xₘ minimize the initial function F (x₁, x₂, . . . , xₖ, . . . xₘ) from Equation 1. These numerical values describe the optimal settings used by the language annotator component 266 to accelerate the user's original source code.

In order to directly sum energy and timing values, both must be transformed into quantities with the same units. One way to do this is to compute the average power usage of the user's machine over a period of time. The average power draw over a period of time t is P_{avg}(t)=Eₜ/t. Defining T̅_{prog}=T_{prog}/T and Ē_{prog}=E_{prog}/Eₜ creates unit-less quantities with appropriate scaling that can be reasonably combined in proportional amounts.

After the problem is constructed, the optimizer component 270 iterates over candidate solutions until it halts after reaching some pre-defined convergence criteria. The final x vector produced describes the optimal settings used by the language annotator component 266 in step 310 to accelerate the user's original source code.

A practical choice to solve this formulation is a direct-search-optimizer (DFO) algorithms such as those offered by the NOMAD 4 software package. These sets of direct search algorithms can handle both real, integer and categorical parameters which apply nicely to such parameters as loop unrolling with partial specialization as in the MPC drone example described herein below. There is also support for large scale parallel search which is useful for optimizing larger code bases. The solution offered also has optimality guarantees that meta-heuristic algorithms such as genetic algorithms do not offer.

The end result will produce a locally optimal program subject to the user's requirements. In many cases, real world benefits can include reduced power requirements, improved dynamic responsiveness, necessity for less expensive computer chips, and lower human maintenance costs. In many embodiments, the system 250 allows the user to maintain a single version of their program—rather than having to maintain (e.g. modifying, testing and synchronizing code behavior) the original source code alongside one or more modified copies of the original.

For an exemplary application of the process 300, consider a self-navigating drone application. One technique to compute a trajectory to a pre-defined destination is to repeatedly solve the linearized Model Predictive Control (MPC) problem several times every second:

$${min}_{x} \frac{1}{2} {x}^{′} Hx + {g}^{T} x \qquad [ 2 ]$$

### Subject to:

$$Ax \leq b$$

$$Cx = d$$

In this situation, x is a vector of variables that represent the drone's position, velocity and internal state at fixed time intervals tₛₜₐᵣₜ, t₁, t₂, . . . , t_{end}. The matrix H and vector f model the interactions between the drone's internal state and how all these factors affect the final position and velocity. The matrices A and C contain constraints on the drone's movement to avoid an unsafe trajectory.

Consider the situation where the user wishes to control a drone with four rotors. A solution to a linearized Model Predictive Control problem, Equation 2 above, could direct the drone where to move at each time step based on where the model believes the drone will be 10 time steps into the future. Using this prediction model, the motion of the drone over 15 time steps could be simulated. This “looking ahead” approach at each time step helps the drone avoid collisions with obstacles or account for other environmental changes. With even larger predictive time horizons, safer trajectories can be mapped out at the expense of solving larger, more complicated problems.

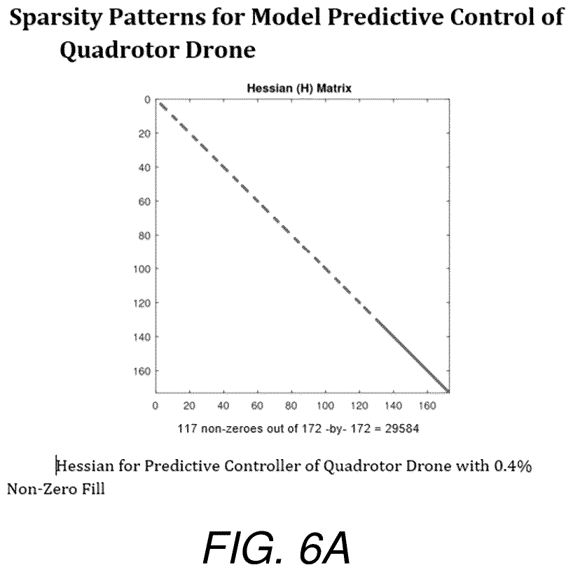

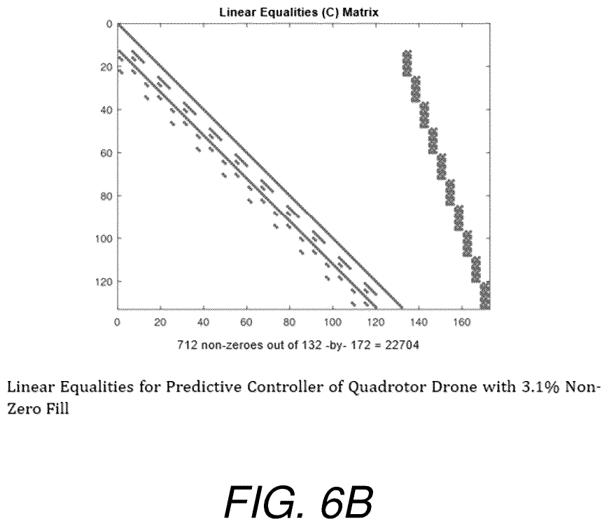

Inefficiencies, in both time and energy, occur when generating and compiling code to solve this problem. For example, auto-generated C code for the MATLAB quadprog active set solver does not take into account any of the structure of the user's problem. FIGS. 6A and 6B show the non-zero pattern for matrices H and C (the matrix A contains bounds on x and can be optimized as inputs lb and ub in the MATLAB code). For many solutions, matrices H, and C contain non-zero patterns. These matrices are almost completely zero except for a few bands and blocks. This means that performing linear algebra operations with them—which almost exclusively involve addition and multiplication—will involve wasting large amounts of computational resources.

The quadprog routine in the source code could require a total of 51 feasibility iterations to complete a full simulation. The bottleneck of each iteration involves calculating the matrix vector products Hx and Cx−d in order to compute derivatives and optimality measures. In this example, it takes size (H)+size (C)=172×172+132×172=52288 add/multiply operations per iteration to compute these matrix operations on standard optimized hardware. Over 15 time steps (51 iterations), this is over 2.5M add/multiply operations. However, because these matrices are fixed across iterations, their structure can be embedded into the source code—reducing the total add/multiply operations for Hx and Cx−d down to 51 * (nonzeros(H)+nonzeros(C)=42279−a 98% reduction in work. Preliminary tests have found a 150× speedup for computing H*x and a up to 50× speedup for computing C*x−d when optimized on a modern Intel (Model i5-1340P) processor with instruction vectorization amount set to 4.

The system 250 runs the user interface 252, which allows the user to select the compiler, use-case data, and specify that the driver file for the sym-ca program is compute_Hx.c. FIG. 4C shows an exemplary command for inputting structural data into compute_Hx.c.

As FIG. 4C shows, the driver file for the sym-ca program is compute_Hx.c.

The option driver-function denotes the entry point where all analysis and timing will begin. Because the file compute_Hx.c only contains one function, this option is not strictly needed.

The option fixed-inputs is assigned a MAT file. This file contains variable names in MATLAB corresponding to those inputs in compute_Hx.c. In addition, MAT files provide data type information—whether a variable is a matrix, vector or scala—so the sym-ca program can identify the input H as a dense 2-D matrix. As such, sym-ca will try to compress H into only its non-zero entries in an attempt to minimize computation. For matrices with a lot of nonzeros, it may decide that the matrix should not be compressed.

The option timing-inputs are the other inputs to compute_Hx that are not necessarily fixed in structure. These will be used along with the fixed data values/structure to perform timing/energy analysis.

The option c-compiler sets the compiler to the GNU C Compiler. This is the default compiler shipped with most Linux operating systems.

As described hereinbelow, time-weight and energy-weight values correspond to how much the user would like the process to be optimized for time or energy in comparison to one another. In this example, time and energy are weighted equally by the user.

The option cache-constraint limits the output code size (if possible) to not exceed the user's L2 cache size.

The next two options, target-hardware and language-syntax request that the final optimized code be returned in x86 assembly.

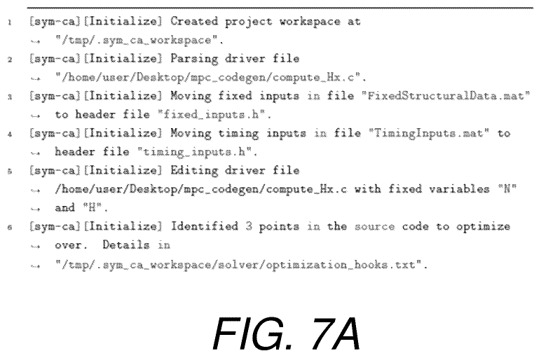

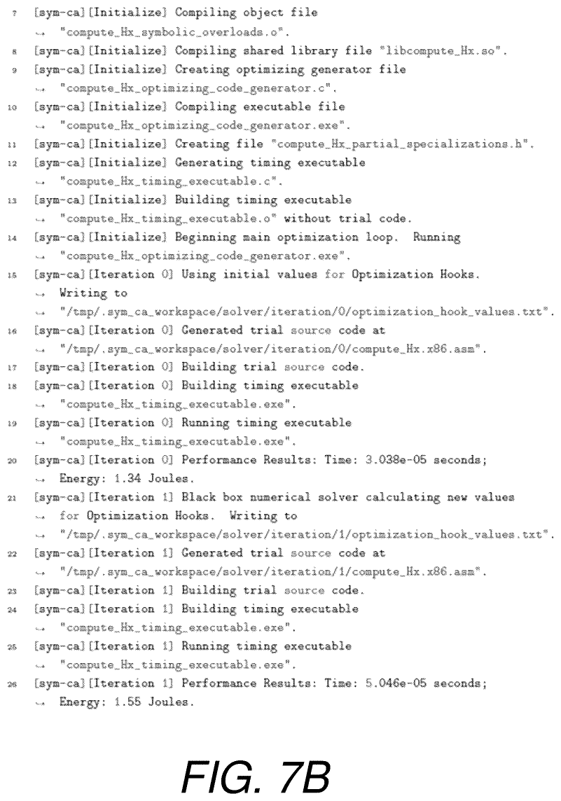

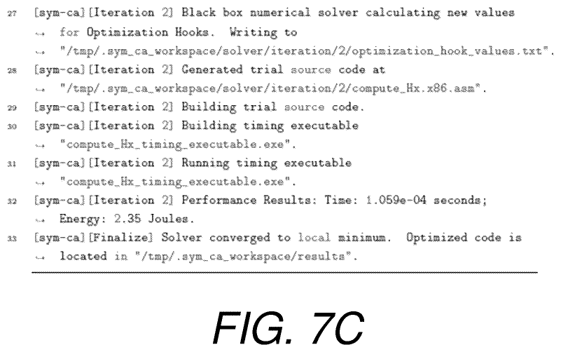

The final option requests that the program print out all intermediate steps when optimizing the code. An exemplary output of running the command is shown in FIGS. 7A-7C.

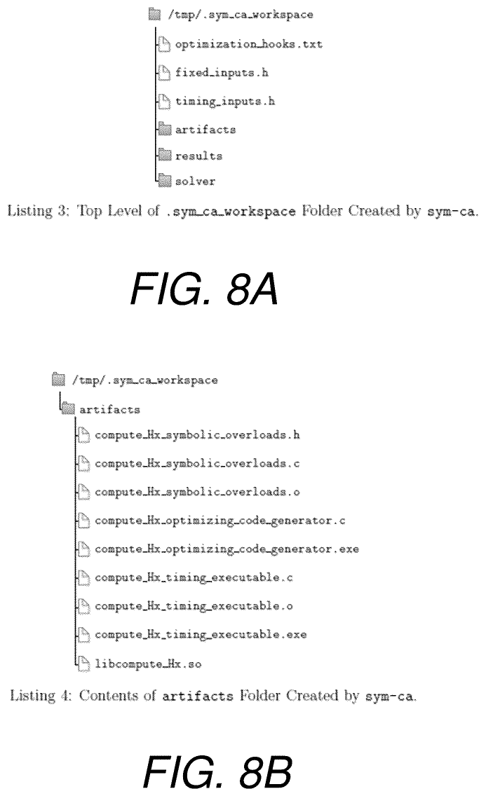

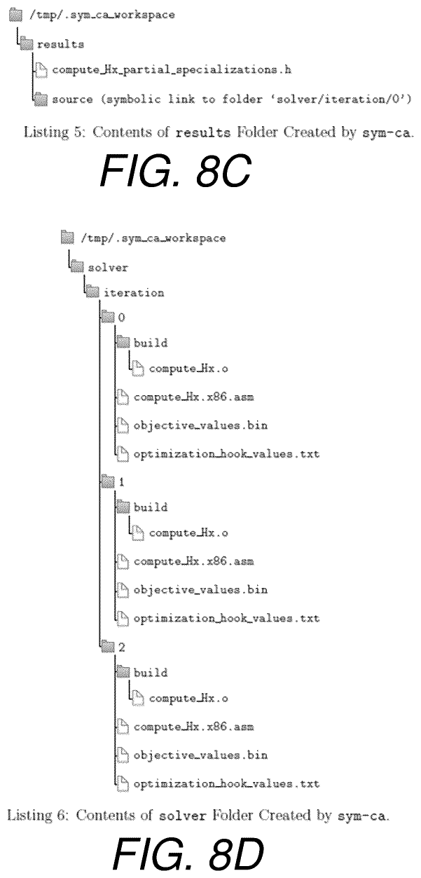

After receiving inputs via the user interface 252, the system 250, in various embodiments, can create a navigable workspace folder the user could navigate by the exemplary program:/tmp/.sym_ca_workspace, which is shown in exemplary FIGS. 8A-8D. A main user interface creates the folder structure shown in FIG. 8A, where all the results will be stored. See also, line 1 of FIG. 7A.

At step 307, the system 250 receives the source code specified in step 254. The system 250 checks functions against library-of-functions of step 308. The Scanner/Parser analyzes the driver file provided by the user. In this example, no library substitutions were identified because the function was self-contained. Step 307 corresponds to line 2 of FIG. 7A.

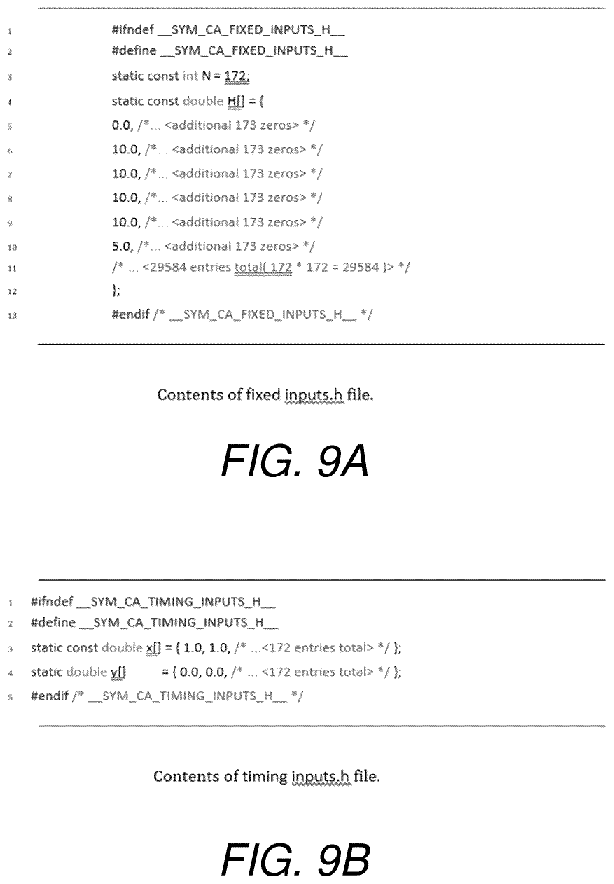

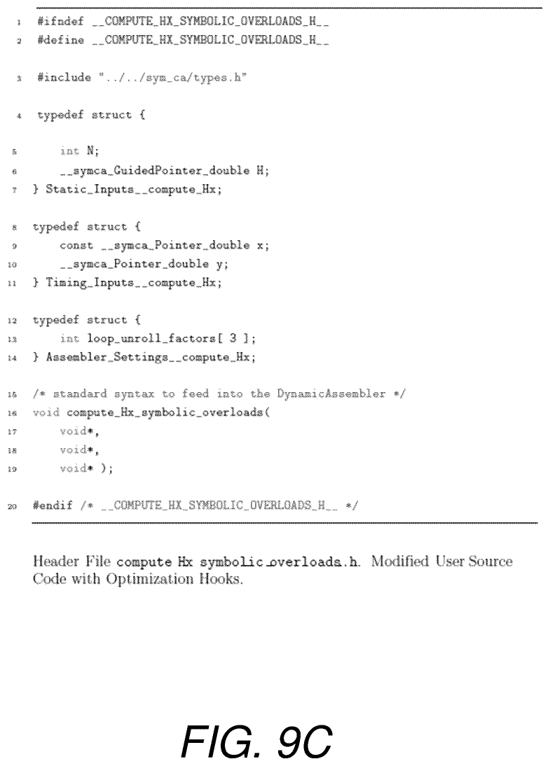

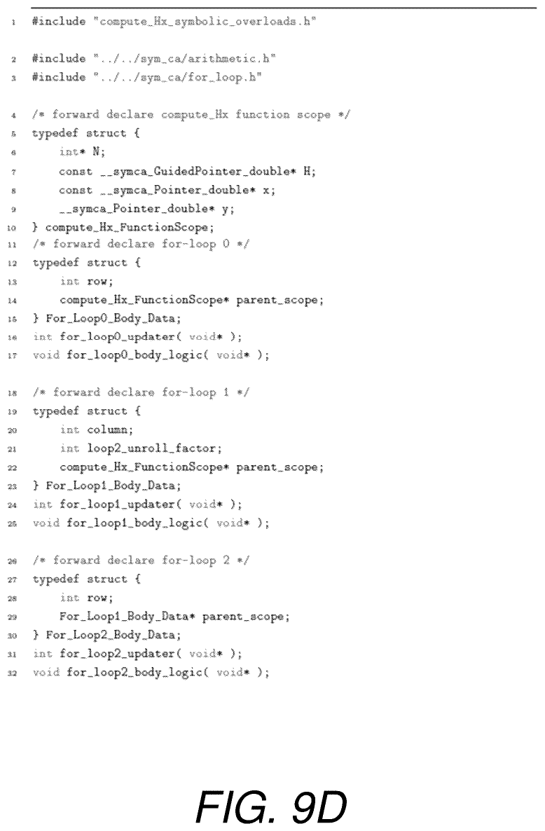

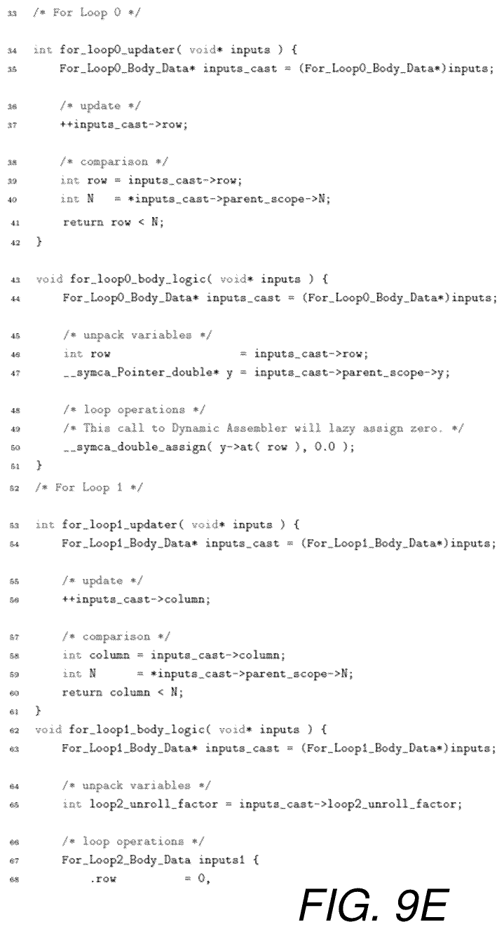

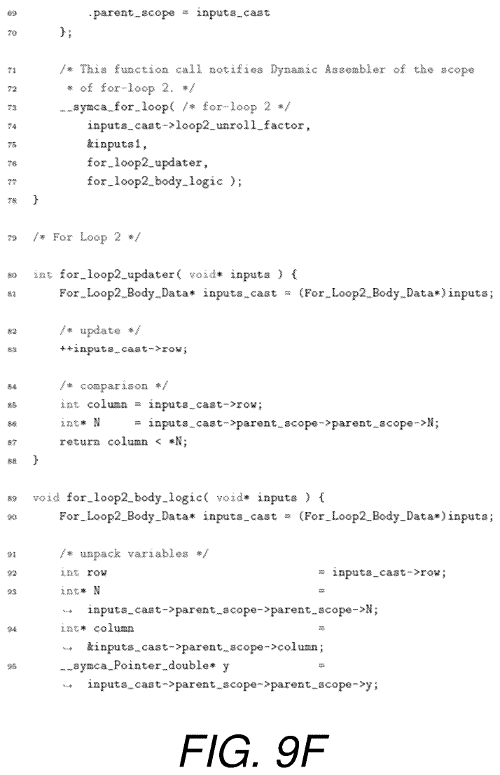

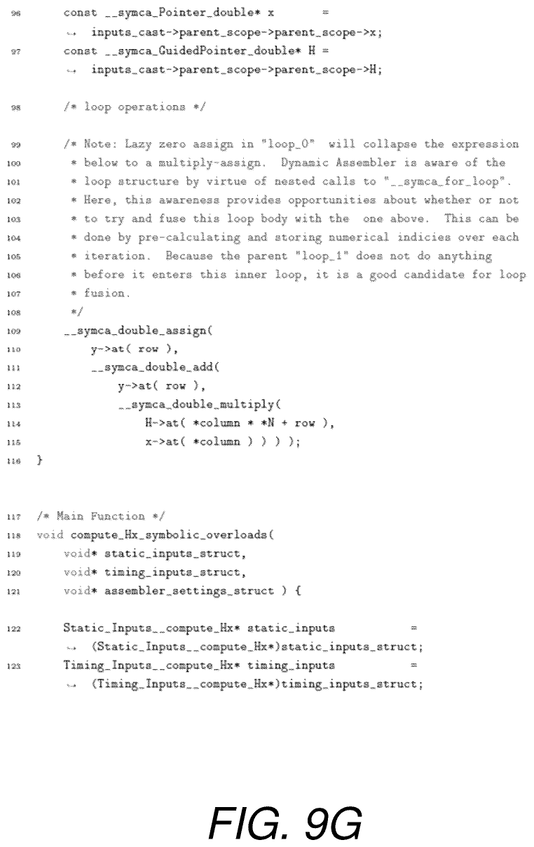

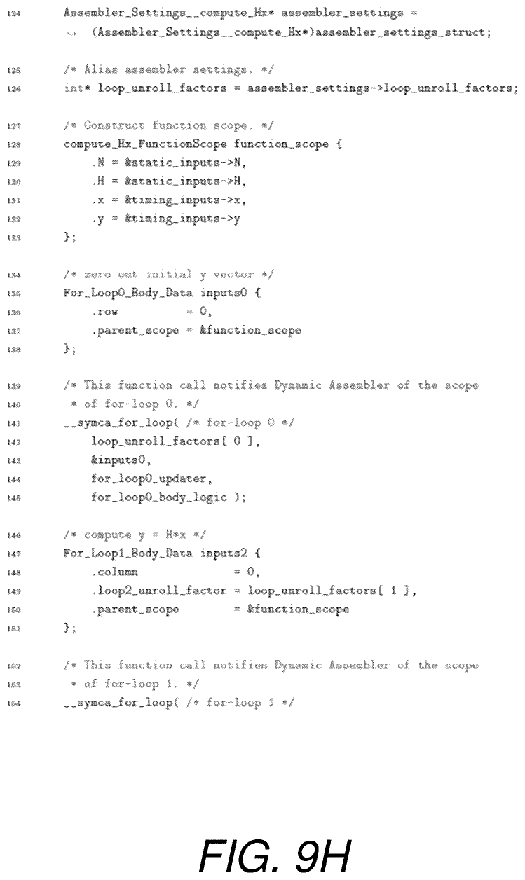

At line 3 of FIG. 7A, which can correspond to step 252 in some embodiments, the system 250 can read the MAT file “FixedStructuralData.mat” and place its inputs into the C header file fixed_inputs.h located at the top of the workspace folder in FIG. 8A. Its contents are shown in FIG. 9A. The inputs H and N are labelled as the fixed inputs and passed to the Language annotator component 266.

At line 4 of FIG. 7A, which can correspond to step 252 in some embodiments, the system 250 can read the MAT file “TimingInputs.mat” and place its input into the C header file timing_inputs.h located at the top of the workspace folder in FIG. 8A. This will be used to build the timing executable before the main loop is executed. Its contents are shown in FIG. 9B.

At line 5 of FIG. 7A, which can correspond to step 310 in some embodiments, the system 250, knowing the fixed inputs are H and N, modify a copy of compute_Hx.c called compute_Hx_symbolic_overloads.c and stores the modified source code into the artifacts/folder, e.g., see FIG. 8B. A header file compute_Hx_symbolic_overloads.h can also be created so the modified source can be imported later. The generated source code is shown in FIGS. 9C-9I, wherein FIGS. 9D-9I, representing source file compute_Hx_symbolic_overloads.c.

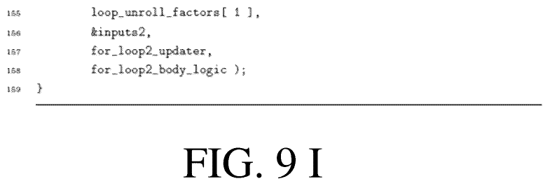

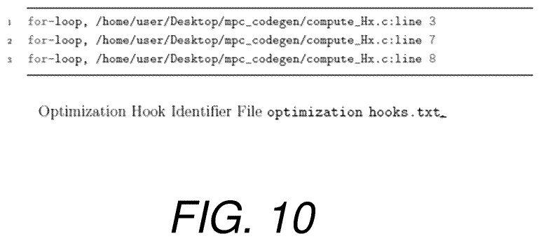

At line 6 of FIG. 7A, which can correspond to step 310 in some embodiments, the system 250 reports the results of its analysis. The Optimization Hooks that were identified are written to optimization_hooks.txt, e.g., see FIG. 8A. The contents of this file are shown in FIG. 10. This informs the user that three for-loops were identified for unrolling. These hooks will form the basis for a numerical optimization problem with three variables.

At line 7 of FIG. 7B, which can correspond to step 312 in some embodiments, the system 250 compiles the symbolic overloads file and the resulting file is stored in the artifacts/shown in FIG. 8B. At line 8 of FIGS. 7A and 7B the system at step 312 can create a shared library that glues all modified files together. This can also be stored in the artifacts/folder.

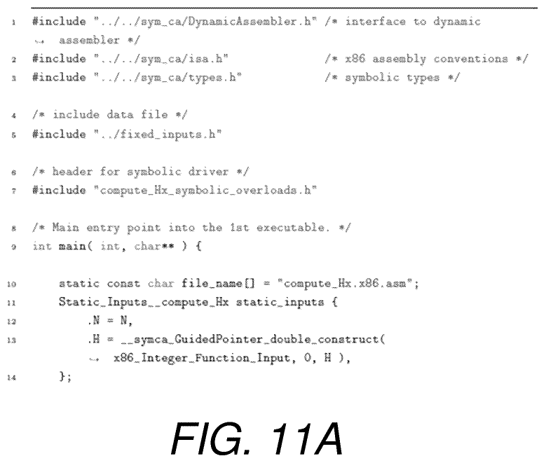

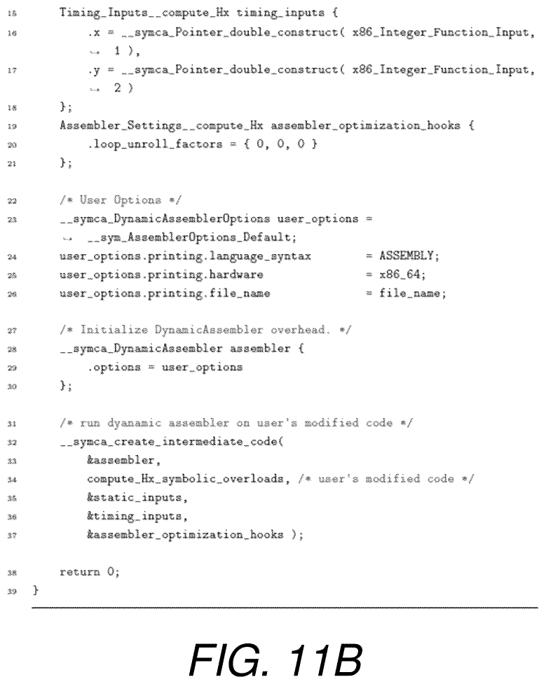

At line 9 of FIG. 7B, which can correspond to step 312 in some embodiments, the system 250 creates the source code for the first executable, e.g., compute_Hx_optimizing_code_generator.c—and stored in the artifacts/folder shown in FIG. 8B. Contents can be found in FIGS. 11A-11B.

At line 10 of FIG. 7B, which can correspond to step 312 in some embodiments, the system 250 compiles the 1st executable, which corresponds to step 314. The executable compute_Hx_optimizing_code_generator.exe is stored in the artifacts/folder shown in FIG. 8B.

At line 11 of FIG. 7B, which can correspond to step 312 in some embodiments, the system 250 creates the file compute_Hx_partial_specializations.h. This is an interface file for the final C code that will be generated by the main optimization loop in FIG. 2. This does not change between iterations so it is created once and stored in the results/folder shown in FIG. 8C. The contents of this file are shown in FIG. 13.

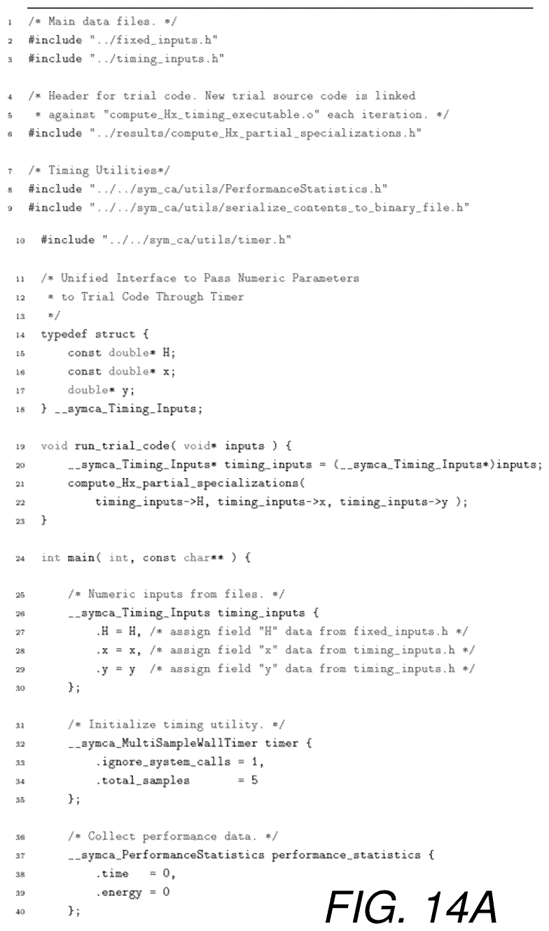

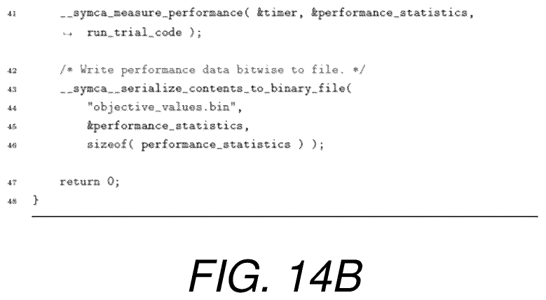

At line 12 of FIG. 7B, which can correspond to step 312 in some embodiments, the system 250 generates the source code for the second (timing) executable and stores it in the artifacts/folder, which is shown in exemplary FIG. 8B. The contents are shown in FIGS. 14A-14B.

At line 13 of FIG. 7B, which can correspond to step 312 in some embodiments, the system 250 generates the source code for the timing executable without linking to the current trial code. This means building the timing executable in the main loop will only require linking compute_Hx_timing_executable.o against the assembly code generated each iteration, which can significantly speeds up the timing process in some embodiments.

At line 14 of FIG. 7B, which can correspond to step 316 in some embodiments, the system 250 runs compute_Hx_optimizing_code_generator.exe, which is the executable from step 314.

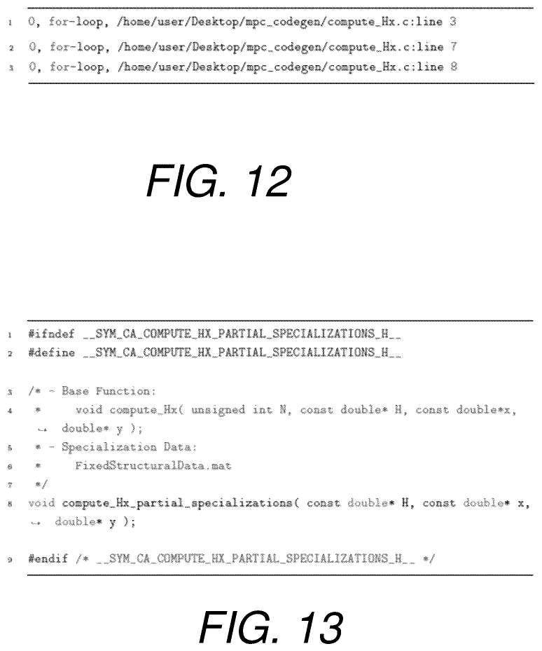

At line 15 of FIG. 7B, which can correspond to step 316 in some embodiments, the system 250 performs a cold start for the initial iteration. In this case, the loop rolling Optimization Hooks are set to zeros—meaning all loops are unrolled. The file optimization_hook_values.txt is written to solver/iteration/0 e.g., FIG. 8D in order to audit the process. Contents are shown in FIG. 12.

In some embodiments, a user can choose to warm start the process with a custom optimization_hook_values.txt file. In most cases, this will re-used from a previous run of the sym-ca program—though it can be written by hand if desirable. The user can add the—warm-start=<file> option to their sym-ca command. This can be useful for significantly speeding up subsequent runs of the process pipeline if the user has only made minor changes to their source code. If the total number and specific types of optimization hooks in the warm start file do not match those written to optimization_hooks.txt—say compute_Hx is rewritten to assume y is zeroed out by the user and contains only two for-loops—then the process pipeline falls back to the cold start.

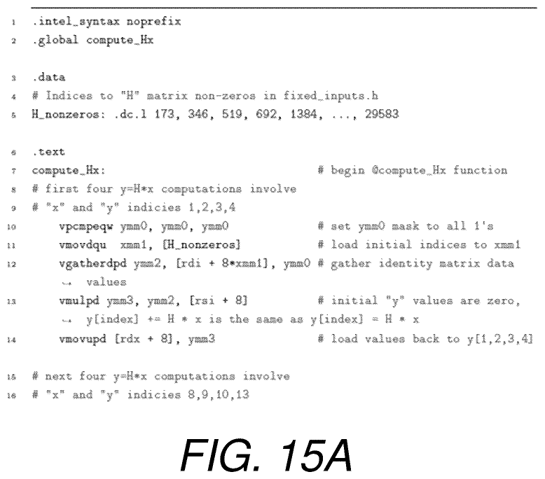

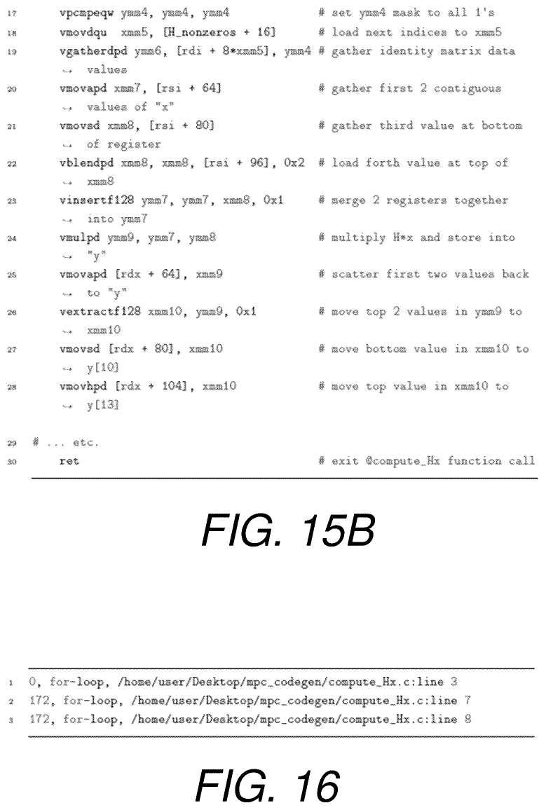

At line 16 of FIG. 7B, which can correspond to step 316 in some embodiments, the system 250 runs the first executable file with initial settings and outputs the first trial code file 320. The system 250 makes calls into the Dynamic Assembler 318. The first trial code file 320 is stored in the solver/iteration/0 subfolder shown in exemplary FIG. 8D. Contents with explanatory comments are provided in FIGS. 15A-15B. In unrolling all the loops, the zero-ing computation from the first loop (Line 3 of compute Hx.c) and the computation from the double loops (Lines 7 and 8 in compute Hx.c) have been interleaved. This avoids a more traditional compiler's strategy of executing the first loop—introducing a slow memory store—then executing the remaining two nested loops. In Iteration 1, we shall see that by re-rolling loops, this interleaving behavior optimization is undone—reducing the performance of the overall program.

At line 17 of FIG. 7B, which can correspond to step 322 in some embodiments, the system 250 builds the trial code. The build artifacts are stored in solver/iteration/0/build, which is shown in exemplary FIG. 8D.

At line 18 of FIG. 7B, which can correspond to the second executable 324 in some embodiments, the system 250 links the file compute_Hx_timing_executable.o against the build artifacts in solver/iteration/0/build. This creates the executable file compute_Hx_timing_executable.exe in the artifacts/folder. When run, it will collect performance statistics of the assembly code in solver/iteration/0/compute_Hx.x86.asm.

At line 19 of FIG. 7B, which can correspond to step 326 in some embodiments, the system 250 runs the timing executable compute_Hx_timing_executable.exe and the performance results are collected. The raw performance data is written to objective values.bin in folder solver/iteration/0 shown in FIG. 8D. This is a binary file that stores the exact 64-bit values of the time and energy values. It is these exact values that are read and used by the main process pipeline to compare source code performance across multiple iterations. At line 20 of FIGS. 7A and 7B, the system 250 can report rounded performance results for convenience and quick auditing.

At line 21 of FIG. 7B, which can correspond to step 328 in some embodiments, the system 250 begins a next iteration with the black box numerical solver taking the performance result data and computing new numerical Optimization Hooks values for the next iteration. An example of what might be calculated is given in FIG. 16. Here, the first loop (Line 3 of compute_Hx.c) is going to be completely re-rolled as the hook for the first loop is set to 172 which is the total number of iterations that will be run.

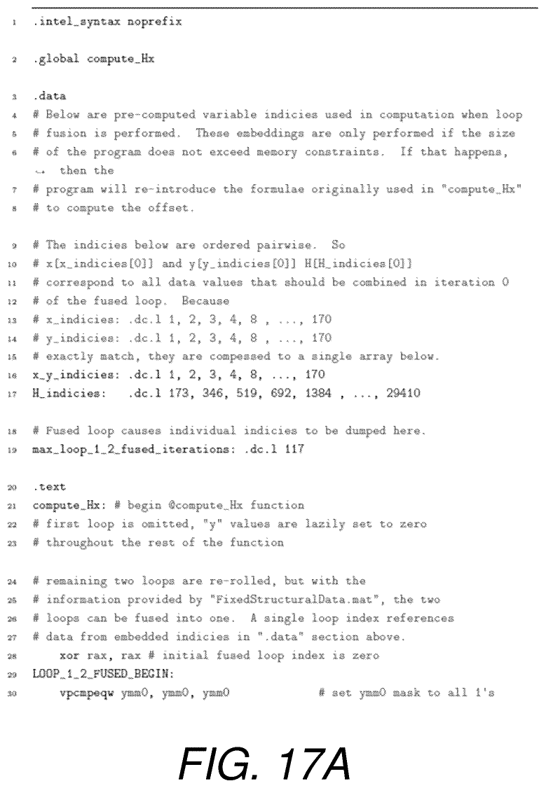

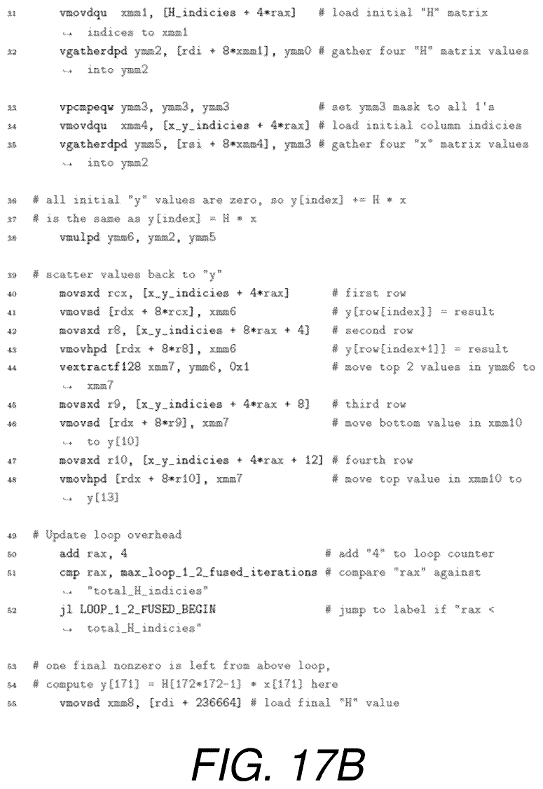

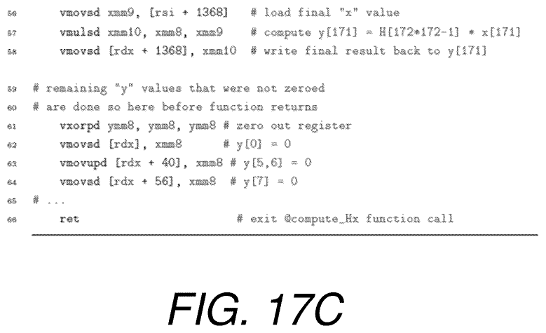

At line 22 of FIG. 7B, which can correspond to step 328 in some embodiments, the system 250, using the new hook values, feeds back to step 316 and generates a new source code file. The contents are shown in FIGS. 17A-17C.

Lines 23-32 of FIGS. 7B-7C, repeat another iteration of the process described hereinabove with respects to steps 316 to step 328. In various embodiments, these steps can be repeated through many iterations.

At line 33 of FIG. 7C, which can correspond to step 328 in some embodiments, the system 250 converges to a local minimum. They system 250 can then compile the code associated with this convergence and output a runnable program.

A symbolic link is created in the results/folder to the iteration that minimized the user's time/energy weighted objective function. Here, this was at the first iteration, so the symbolic link points to the generated code at solver/iteration/0. The compiled code is located at solver/iteration/0/build shown in FIG. 8D.

It is important to understand that the optimization procedure requires both the Dynamic Assembler for hardware considerations and the Black Box Numerical Optimizer for streamlining the software organization and code itself. This is a fundamentally new approach to solve performance optimization problems in software. It can be generalized to a vast variety of problems including those involving Artificial Intelligence and Quantum Computing. It is also important to understand this procedure allows the Black Box Numerical Optimizer to optimize its own source code. Thereby maintaining its effectiveness as software becomes increasingly more complex over time.

In some embodiments, the process 300 can be enhanced by adding libraries of pre-edited domain-specific functions. These are hand-written algorithms where custom Optimization Hooks are pre-defined.

While the Language Editor acts as a supervisor—flagging any potential source of slowdown and enabling the rest of the process to iteratively maximize efficiency—these functions are identified by the Scanner/Parser as being “special” and the Language Editor is notified that their code shall be generated by the implementations found in a “Library of Functions”.

When building the 1st Executable, each library function will be linked against the other source code modified by the Language Editor. The Dynamic Assembler and the Black Box Numeric Optimizer can either adjust the numerical values of these custom Optimization Hooks using traditional strategies or (optionally) custom strategies can be added to adjust the iterative behavior in order to accelerate the overall process.

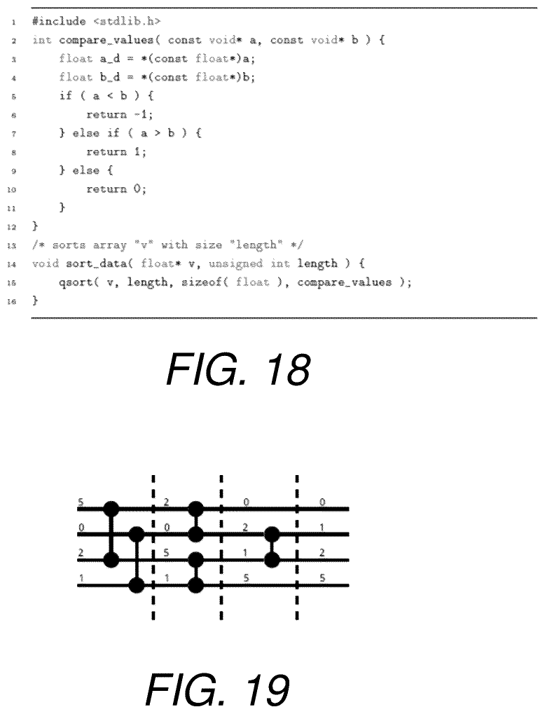

Consider the example of sorting an array of numbers from largest to smallest. In the C programming language, this is the qsort( ) function (short for “quick sort”). The user may call the function shown in FIG. 18.

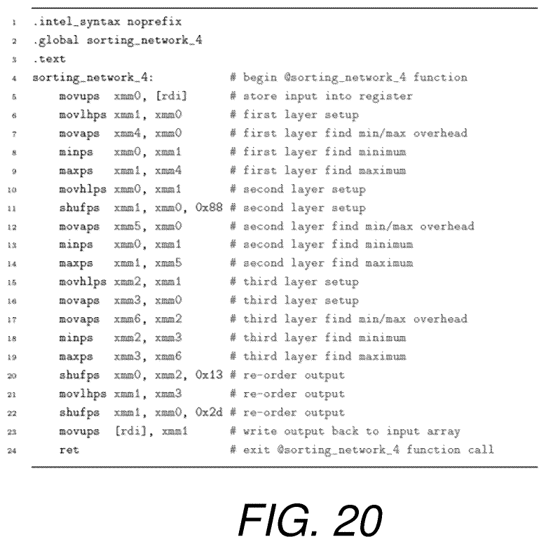

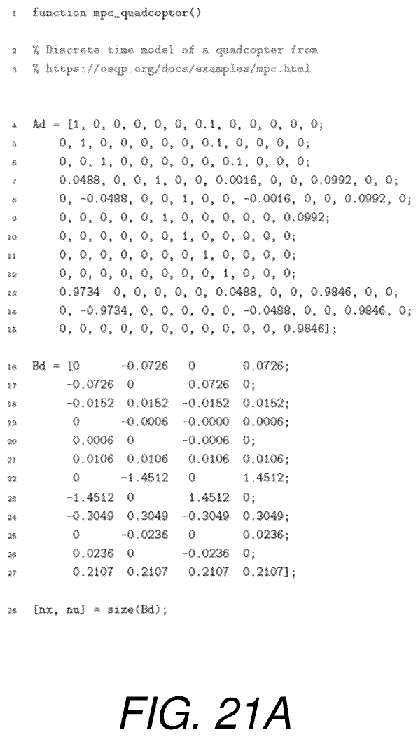

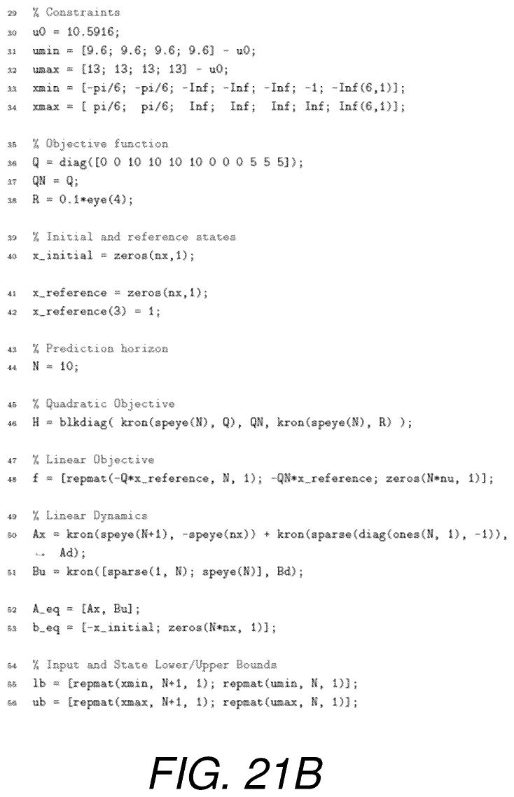

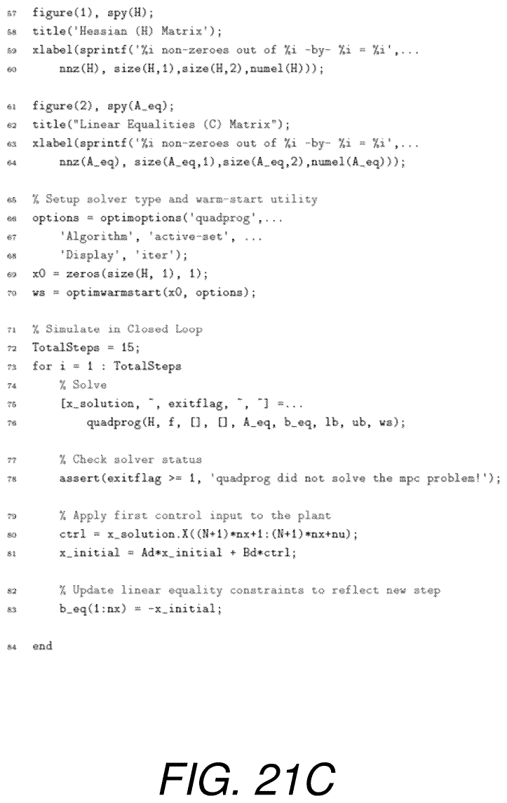

When the user has a fixed number of inputs, algorithm-specific strategies can be employed to improve the performance of sorting N values. If the user sets N=4, for example, the process pipeline can be instructed to produce an optimal sorting network FIG. 20 of size 4.

FIG. 19 shows an exemplary sorting network for 4 inputs. Vertical bars denote comparison operations that output the minimum on the upper wire and the maximum on the lower wire.

For larger sizes where the optimal network structure is not known (currently N>12), a custom hook is inserted that restricts how large a sorting network can grow before re-introducing for-loops. For unrolled computation, a reasonable strategy involves growing the networks using the Batcher even-odd merge sort algorithm. This can generate sorting networks at any size. When the problem reaches a certain size, these sorting networks will run into hardware limitations. It will then become advantageous to re-roll loops. Doing so will involve passing the results of these large sorting networks to a traditional merge sort algorithm (or one of its many variations). The Optimization Hook will be controlled by the black box numeric optimizer and will be used to increase or decrease the maximum sorting network size.

One can appreciate how hand-writing targeted strategies for a domain-specific function can better improve performance compared to a generic optimization strategy or heuristic.

The schematic flow chart diagrams included herein are generally set forth as logical flow chart diagrams. As such, the depicted order and labeled steps are indicative of one embodiment of the presented process. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the process. For example, an arrow may indicate a waiting or monitoring period of unspecified duration between enumerated steps of the depicted process. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Additionally, the order in which a particular method occurs may or may not strictly adhere to the order of the corresponding steps shown. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Additionally, examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system” or one or more “components.” Furthermore, aspects of the present invention may take the form of a computer program product embodied in one or more computer readable medium(s) having program code embodied thereon.

A system as used herein refers to any device, process, service, or combination thereof. A system may be implemented using components such as hardware, software, firmware, a special-purpose device, or any combination thereof. A system may be integrated into a single device or it may be distributed over multiple devices. The various components of a system may be co-located or distributed. The system may be formed from other systems and components thereof.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Components may also be implemented in software for execution by various types of processors. An identified component of computer readable program code may, for instance, comprise one or more physical or logical blocks of computer instructions which may, for instance, be organized as an object, procedure, or function. Nevertheless, the executables of an identified component need not be physically located together, but may comprise disparate instructions stored in different locations which, when joined logically together, comprise the component and achieve the stated purpose for the component.

Indeed, a component of computer readable program code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. Where a component or portions of a component are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In some embodiments, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. An autonomous computer implemented method for compiling a computer program, the method comprising:
receiving a source code for a computer program, use-case data, and user-selected operating parameters;
inserting optimization hook code into the source code—not requiring user input;
compiling the source code with the optimization hook code;
executing the compiled code with the optimization hooks code, wherein the optimization hooks of the optimization hook code are set to an initial value;
receiving intermediate code based upon the executing;
compiling the received intermediate code;
executing the compiled received intermediate code using the use-case data;
evaluating the executing the compiled received intermediate code using the use-case data based upon one or more user-defined performance metrics; and
identifying code associated with the one or more user-defined performance metrics; and
compiling the identified code into a runnable computer program.

2. The method of claim 1, wherein the inserting optimization hook code into the source code is based upon identified code loops.

3. The method of claim 1, wherein the one or more user-defined performance metrics correspond to a time or an energy performance metric.

4. The method of claim 1, further comprising:
receiving a pre-defined numerical value corresponding to a range, the range including a plurality of numbers to use iteratively as optimization hooks;
for each numerical value of the range:
iteratively executing the compiled code with the optimization hooks code set to a number within the range;
iteratively receiving intermediate code based upon the iteratively executing;
compiling the iteratively received intermediate code;
executing the compiled iteratively received intermediate code using the use-case data;
evaluating the executing the compiled iteratively received intermediate code using the use-case data based upon one or more user-defined performance metrics; and
identifying code associated with a numerical value within the range corresponding to preferential performance metrics, the performance metrics determined based upon a host processor's instruction set architecture; and
compiling the identified code into a runnable computer program.

5. The method of claim 4, wherein the preferential performance metrics are indicated when a convergence has occurred.

6. The method of claim 5, further comprising:
monitoring for a convergence using a mixed integer nonlinear optimization problem technique.

7. The method of claim 4, wherein the preferential performance metrics are indicated when a local minima of either a time or energy metric is determined.

8. The method of claim 4, wherein the preferential performance metrics are indicated when a local minima of a weighted metric of time and energy is determined.

9. The method of claim 4, wherein the source code comprises one or more library functions, wherein the library functions are optimized based upon pre-defined parameters associated with the plurality of numbers of the range.

10. The method of claim 1, wherein the intermediate code is byte-code.

11. A computer implemented method for compiling a computer program, the method comprising:
receiving a source code for a computer program, and user-selected operating parameters, wherein the source code includes one or more optimization hook code calls to a library of functions component, wherein the library of functions component comprises a plurality of pre-defined functions;
receiving a plurality of numerical values to use iteratively as optimization hooks, wherein at least one function within the library of function component is associated with a plurality of pre-defined values, the pre-defined values each associated with one of the numerical values;
compiling the source code with the optimization hook code calls and the numerical values;
for each numerical value:
iteratively executing the compiled code with the optimization hooks code calls into the library of functions component,
iteratively receiving intermediate code based upon the iteratively executing,
executing the iteratively received intermediate code using the optimization hooks code calls into the library of functions component, and
evaluating the executing the iteratively received intermediate code based upon one or more user-defined performance metrics;
identifying code associated with a numerical value corresponding to preferential performance metrics; and
compiling the identified code associated into a runnable computer program.

12. The method of claim 11, wherein the intermediate code is byte-code.

13. The method of claim 11, wherein the optimization hook code controls a quantify that a code loop is unrolled.

14. The method of claim 11, wherein the one or more user-defined performance metrics correspond to time or energy performance and are based upon a host processor's instruction set architecture.

15. The method of claim 11, wherein the preferential performance metrics are indicated when a convergence has occurred.

16. The method of claim 15, further comprising:
monitoring for a convergence using a mixed integer nonlinear optimization problem technique.

17. The method of claim 15, wherein the preferential performance metrics are indicated when a local minima of either a time or energy metric is determined.

18. The method of claim 15, wherein the preferential performance metrics are indicated when a local minima of a weighted metric of time and energy is determined.

19. A computer implemented method for compiling a computer program, the method comprising:
receiving a source code for a computer program, and user-selected operating parameters, wherein the source code includes one or more calls into a library of functions component, wherein the library of functions component comprises a plurality of pre-defined functions, including an optimization hook code;
receiving a plurality of numerical values to use iteratively with the optimization hook code, wherein at least one function within the library of function component is associated with a plurality of pre-defined values, the pre-defined values each associated with one of the numerical values;
compiling the source code with the optimization hook code and the numerical values;
for each numerical value:
iteratively executing the compiled code with the optimization hooks code into the library of functions component,
iteratively receiving intermediate code based upon the iteratively executing,
executing the iteratively received intermediate code using the optimization hooks code into the library of functions component, and
evaluating the executing the iteratively received intermediate code based upon one or more user-defined performance metrics;
identifying code associated with a numerical value corresponding to preferential performance metrics; and
compiling the identified code associated into a runnable computer program.

20. The method of claim 19, wherein the preferential performance metrics are based upon a host processor's instruction set architecture.

21. The method of claim 19, wherein the intermediate code is byte-code.

22. The method of claim 19, wherein the optimization hook code controls a quantify that a code loop is unrolled.

23. The method of claim 19, wherein the preferential performance metrics correspond to time or energy performance and are indicated when a convergence has occurred.

24. The method of claim 23, further comprising:
monitoring for a convergence using a mixed integer nonlinear optimization problem technique.

25. The method of claim 23, wherein the preferential performance metrics are indicated when a local minima of either a time or energy metric is determined.

26. The method of claim 23, wherein the preferential performance metrics are indicated when a local minima of a predefined, weighted metric of time and energy is determined.
